(19) United States
(12) Patent Application Publication
(10) Pub. No.: US 2026/0343287 A1
(43) Pub. Date: Oct. 29, 2026

(54) INTER-RAT MEASUREMENTS WITHOUT MEASUREMENT GAPS

(71) Applicant: Telefonaktiebolaget LM Ericsson (publ), Stockholm (SE)

(72) Inventors: Zhixun TANG, Täby (SE); Ming LI, Stockholm (SE); Muhammad Ali KAZMI, Reston, VA (US)

(21) Appl. No.: 19/114,524

(22) PCT Filed: Sep. 27, 2023
(86) PCT No.: PCT/SE2023/050944

§ 371 Date: Mar. 24, 2025

(30) Foreign Application Priority Data
Sep. 30, 2022 (WO) PCT/CN2022/123268

(51) Int. Cl. H04W 24/10; H04W 88/06

(52) U.S. Cl. CPC H04W 24/10; H04W 88/06

(57) ABSTRACT

Methods implemented by wireless devices and network nodes are disclosed, as well as corresponding wireless devices and network nodes. According to an embodiment, a wireless device is configured to communicate with a network node. The wireless device receives a configuration for inter-radio access technology, RAT, measurement without measurement gaps. The configuration defines an effective measurement window for performing inter-RAT measurement without measurement gaps. The wireless device performs inter-RAT measurement without measurement gaps in the effective measurement window on at least one cell based on the configuration.

### TECHNICAL FIELD

The present disclosure relates to wireless communications, and in particular, to inter-radio access technology (RAT) measurements without measurement gaps.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

### Wireless Device Measurements

The wireless device performs measurements on one or more downlink (DL) and/or uplink (UL) reference signal (RS) of one or more cells in different wireless device activity states e.g., radio resource control (RRC) idle state, RRC inactive state, RRC connected state, etc. The measured cell may belong to or operate on the same carrier frequency as of the serving cell (e.g., intra-frequency carrier) or it may belong to or operate on different carrier frequency as of the serving cell (e.g., non-serving carrier frequency). The non-serving carrier may be referred to as inter-frequency carrier if the serving and measured cells belong to the same radio access technology (RAT) but different carriers. The non-serving carrier may be referred to as inter-RAT carrier if the serving and measured cells belong to different RATs. Examples of downlink RS are signals in synchronization signal block (SSB), channel state information RS (CSI-RS), CRS, demodulation reference signal (DMRS), primary synchronization signal (PSS), secondary synchronization signal (SSS), signals in synchronization signal/physical broadcast channel (SS/PBCH) block (SSB), discovery reference signal (DRS), positioning reference signal (PRS), etc. Examples of uplink RS are signals in sounding reference signal (SRS), DMRS etc.

Each SSB carries NR-PSS, NR-SSS and NR-PBCH in 4 successive symbols. One or multiple SSBs are transmitted in one SSB burst which is repeated with certain periodicity, e.g., 5 ms, 10 ms, 20 ms, 40 ms, 80 ms and 160 ms. The wireless device is configured with information about SSB on cells of certain carrier frequency by one or more SS/PBCH block measurement timing configuration (SMTC) configurations. The SMTC configuration including parameters such as SMTC periodicity, SMTC occasion length in time or duration, SMTC time offset with reference to reference time (e.g., serving cell's SFN) etc. Therefore, SMTC occasion may also occur with certain periodicity, e.g., 5 ms, 10 ms, 20 ms, 40 ms, 80 ms and 160 ms.

Examples of measurements are cell identification (e.g., PCI acquisition, PSS/SSS detection, cell detection, cell search, etc.), Reference Symbol Received Power (RSRP), Reference Symbol Received Quality (RSRQ), secondary synchronization RSRP (SS-RSRP), SS-RSRQ, SINR, RS-SINR, SS-SINR, CSI-RSRP, CSI-RSRQ, received signal strength indicator (RSSI), acquisition of system information (SI), cell global ID (CGI) acquisition, Reference Signal Time Difference (RSTD), UE RX-TX time difference measurement, Radio Link Monitoring (RLM), which consists of Out of Synchronization (out of sync) detection and In Synchronization (in-sync) detection, etc.

The wireless device is typically configured by the network (e.g., via RRC message) with measurement configuration and measurement reporting configuration, e.g., measurement gap pattern, carrier frequency information, types of measurements (e.g., RSRP etc.), higher layer filtering coefficient, time to trigger report, reporting mechanism (e.g., periodic, event triggered reporting, event triggered periodic reporting etc.), etc.

The measurements are performed for various purposes. Some example measurement purposes are: wireless device mobility (e.g., cell change, cell selection, cell reselection, handover, RRC connection re-establishment, etc.), wireless device positioning or location determination self-organizing network (SON), minimization of drive tests (MDT), operation and maintenance (O&M), network planning and optimization etc.

### NR Inter-RAT LTE Measurement

In NR, inter-RAT measurements are defined for NR-E-UTRAN FDD and NR-E-UTRAN TDD measurements and are applicable without an explicit E-UTRAN neighbor cell list containing physical layer cell identities, for a wireless device in RRC_CONNECTED state. The inter-RAT measurement are performed in measurement gap or NCSG.

When the wireless device requires measurement gaps or NCSG to identify and measure inter-RAT cells and an appropriate measurement gap pattern or NCSG is scheduled, or when the wireless device is capable of concurrent measurement gap patterns and concurrent measurement gap patterns are scheduled, or an appropriate pre-MG is scheduled and activated, the wireless device may be able to identify a new detectable FDD cell within T_{Identify, E-UTRAN FDD} according to the following expression:

$${T}_{Identify , E - UTRAN FDD} = {T}_{BasicIdentify} \cdot \frac{480}{{T}_{Inter 1}} \cdot {CSSF}_{i nterRAT} ms ,$$

$$where :$$

$${T}_{BasicIdentify} = 480 ms ,$$

T_{Inter1} is defined in the following Table 1, when measurement gap is used, and in Table 2 when NCSG is used.

TABLE 1
Minimum available time for inter-RAT measurements
when measurement gap is configured

| | | | Minimum |
|---|---|---|---|
| | | | available |
| | | | time for |
| | | | inter-frequency |
| | | Measurement | and inter-RAT |
| | | Gap | measurements |
| Gap | | Repetition | during 480 ms |
| Pattern | MeasurementGap | Period | period |
| Id | Length (MGL, ms) | (MGRP, ms) | (Tinter1, ms) |
| 0 | 6 | 40 | 60 |
| 1 | 6 | 80 | 30 |
| 2 | 3 | 40 | 24 ^{Note 1} |
| 3 | 3 | 80 | 12 ^{Note 1} |
| 4 | 6 | 20 | 120 ^{Note 1} |
| 6 | 4 | 20 | 72 ^{Note 1, 3, 6} |
| 7 | 4 | 40 | 36 ^{Note 1, 4, 6} |
| 8 | 4 | 80 | 18 ^{Note 1, 5, 6} |
| 10 | 3 | 20 | 48 ^{Note 1} |

^{NOTE 1} :
When determining wireless device requirements using Tinter1 for gap pattern IDs 2, 3, 4, 6, 7, 8, 10, Tinter1 = 60 for gap pattern IDs 2, 4, 6, 7, 10, and Tinter1 = 30 for gap pattern IDs 3 and 8 shall be used.
NOTE 2:
Measurement gaps pattern configurations applicability is as specified in Table 9.1.2-1 in 3GPP standards.
^{NOTE 3} :
When this gap pattern is used, the Tᵢₙₜₑᵣ for E-UTRA inter-frequency measurements is 48 ms corresponding to the first 3 ms of the 4 ms gap.
^{NOTE 4} :
When this gap pattern is used, the Tᵢₙₜₑᵣ for E-UTRA inter-frequency measurements is 24 ms corresponding to the first 3 ms of the 4 ms gap.
^{NOTE 5} :
When this gap pattern is used, the Tᵢₙₜₑᵣ for E-UTRA inter-frequency measurements is 12 ms corresponding to the first 3 ms of the 4 ms gap.
^{NOTE 6} :
This gap pattern is applicable for E-UTRA inter-frequency measurements only if gap based NR measurements are also configured.
NOTE 7:
If multiple concurrent gaps are configured, the MGRP is the periodicity of the MG pattern associated to the E-UTRA inter-RAT frequency layers.

TABLE 2
Minimum available time for inter-RAT
measurements when NCSG is configured

| | | | Minimum |
|---|---|---|---|
| | | | available |
| | | | time for |
| | | | inter-frequency |
| | | Visible | and inter-RAT |
| | | Interruption | measurements |
| NCSG | Measurement | Repetition | during 480 ms |
| Pattern | Length | Period | period |
| Id | (ML, ms) | (VIRP, ms) | (Tinter1, ms) |
| 0 | 5 | 40 | 60 |
| 1 | 5 | 80 | 30 |
| 2 | 2 | 40 | 24 ^{Note 1} |
| 3 | 2 | 80 | 12 ^{Note 1} |
| 4 | 5 | 20 | 120 ^{Note 1} |
| 6 | 3 | 20 | 72 ^{Note 1, 3} |
| 7 | 3 | 40 | 36 ^{Note 1, 3} |
| 8 | 3 | 80 | 18 ^{Note 1, 3} |
| 10 | 2 | 20 | 48 ^{Note 1} |

^{NOTE 1} :
When determining wireless device requirements using Tinter1 for NCSG pattern IDs 2, 3, 4, 6, 7, 8, 10, Tinter1 = 60 for NCSG pattern IDs 2, 4, 6, 7, 10, and Tinter1 = 30 for NCSG pattern IDs 3 and 8 shall be used.
NOTE 2:
NCSG pattern configurations applicability is as specified in Table 9.1.2C-1 of 3GPP standards.
^{NOTE 3} :
This NCSG pattern is applicable for E-UTRA inter-frequency measurements only if NCSG based NR measurements are also configured.

CSSF_{interRAT}=CSSF_{within_gap,i} when measurement gaps are configured, or CSSF_{within_nesg,i} when NCSGs are configured, is the scaling factor for the measured inter-RAT E-UTRA carrier i.

### Measurement Gaps

Measurement gap pattern (MGP) is used by the wireless device for performing measurements on cells of the non-serving carriers (e.g., inter-frequency carrier, inter-RAT carriers etc.). In NR, gaps are also used for measurements on cells of the serving carrier in some scenarios, e.g., if the measured signals (e.g., SSB) are outside the bandwidth part (BWP) of the serving cell. The wireless device is scheduled in the serving cell only within the BWP. During the gap, the wireless device cannot be scheduled for receiving/transmitting signals in the serving cell. A measurement gap pattern is characterized or defined by several parameters: measurement gap length (MGL), measurement gap repetition period (MGRP) and measurement gap time offset with respect to reference time (e.g., slot offset with respect to serving cell's SFN such as SFN=0). An example of MGP is shown in FIG. 1. As an example, MGL can be 1.5, 3, 3.5, 4, 5.5 or 6 ms, and MGRP can be 20, 40, 80 or 160 ms. Such type of MGP is configured by the network node and is also called as network controlled or network configurable MGP. Therefore, the serving base station is fully aware of the timing of each gap within the MGP.

In NR there are two major categories of MGPs: per-wireless device measurement gap patterns and per-FR measurement gap patterns. In NR, the spectrum is divided into two frequency ranges namely FR1 and FR2. FR1 is currently defined from 410 MHz to 7125 MHz. FR2 range is currently defined from 24250 MHz to 71000 MHz. The FR2 range is also interchangeably called as millimeter wave (mmwave) and corresponding bands in FR2 are called as mmwave bands. In the future, more frequency ranges can be specified, e.g., FR3. An example of FR3 is frequency ranging between 7125 MHz and 24250 MHz or above 71000 MHz.

When configured with per-wireless device MGP, the wireless device creates gaps on all the serving cells (e.g., PCell, PSCell, SCells etc) regardless of their frequency range. The per-wireless device MGP can be used by the wireless device for performing measurements on cells of any carrier frequency belonging to any RAT or frequency range (FR). When configured with per-FR MGP (if the wireless device supports this capability), the wireless device creates gaps only on the serving cells of the indicated FR whose carriers are to be measured. For example, if the wireless device is configured with per-FR1 MGP then the wireless device creates measurement gaps only on serving cells (e.g., PCell, PSCell, SCells, etc.) of FR1 while no gaps are created on serving cells on carriers of FR2. The per-FR1 gaps can be used for measurement on cells of only FR1 carriers. Similarly, per-FR2 gaps when configured are only created on FR2 serving cells and can be used for measurement on cells of only FR2 carriers. Support for per FR gaps is a wireless device capability, i.e., certain wireless devices may only support per wireless device gaps according to their capability.

RRC message for measurement gap configuration provided by network node to the wireless device is shown below, according to 3GPP standards such as 3GPP Technical Specification (TS) 38.331 v17.1.0:

### MeasGapConfig

The IE MeasGapConfig specifies the measurement gap configuration and controls setup/release of measurement gaps.

### MeasGapConfig Information Element

```
-- ASN1START
-- TAG-NeedForGapsInfoNR-START
MeasGapConfig ::= SEQUENCE {
  gapFR2 SetupRelease { GapConfig }
OPTIONAL, -- Need M
  . . . ,
  [[
  gapFR1 SetupRelease { GapConfig }
OPTIONAL, -- Need M
  gapUE SetupRelease { GapConfig }
OPTIONAL, -- Need M
  ]],
  [[
  gapToAddModList-r17 SEQUENCE (SIZE (1 . . . maxNrofGapId-r17)) OF
GapConfig-r17 OPTIONAL, -- Need N
  gapToReleaseList-r17  SEQUENCE (SIZE (1 . . . maxNrofGapId-r17)) OF
MeasGapId-r17 OPTIONAL, -- Need N
  posMeasGapPreConfigToAddModList-r17
PosMeasGapConfigToAddModList-r17 OPTIONAL, -- Need
N
  posMeasGapPreConfigToReleaseList-r17 Pos MeasGapPreConfigToReleaseList-
r17 OPTIONAL -- Need N
  ]]
}
GapConfig ::= SEQUENCE {
  gapOffset INTEGER (0 . . . 159),
  mgl ENUMERATED {ms1dot5, ms3, ms3dot5, ms4, ms5dot5,
ms6},
  mgrp ENUMERATED {ms20, ms40, ms80, ms160),
  mgta ENUMERATED {ms0, ms0dot25, ms0dot5},
  . . . ,
  [[
  refServCellIndicator ENUMERATED {pCell, pSCell, msg-FR2}
OPTIONAL -- Cond NEDCorNRDC
  ]],
  [[
  refFR2ServCellAsyncCA-r16 ServCellIndex
OPTIONAL, -- Cond AsyncCA
  mgl-r16 ENUMERATED {ms10, ms20}
OPTIONAL -- Cond PRS
  ]]
}
GapConfig-r17 ::= SEQUENCE {
  measGapId-r17 MeasGapId-r17,
  gapType-r17 ENUMERATED {perUE, perFR1, perFR2},
  gapOffset-r17 INTEGER (0 . . . 159),
  mgl-r17 ENUMERATED {ms1, ms1dot5, ms2, ms3, ms3dot5,
ms4, ms5, ms5dot5, ms6, ms10, ms20},
  mgrp-r17 ENUMERATED {ms20, ms40, ms80, ms160},
  mgta-r17 ENUMERATED {ms0, ms0dot25, ms0dot5, ms0dot75},
  refServCellIndicator-r17 ENUMERATED {pCell, pSCell, mcg-FR2}
OPTIONAL, -- Cond NEDCorNRDC
  refFR2-ServCellAsyncCA-r17 ServCellIndez
OPTIONAL, -- Cond AsyncCA
  preConfigInd-r17 ENUMERATED {true}
OPTIONAL, -- Need R
  ncsgInd-r17 ENUMERATED {true}
OPTIONAL, -- Need R
  gapAssociationPRS-r17 ENUMERATED {true}
OPTIONAL, -- Need R
  gapSharing-r17 MeasGapSharingScheme
OPTIONAL, -- Need R
  gapPriority-r17 GapPriority-r17
OPTIONAL, -- Need R
  . . .
}
PosMeasGapPreConfigToAddModList-r17 ::= SEQUENCE (SIZE
(1 . . . maxNrofPreConfigPosGapId)) OF PosGapConfig-r17
PosMeasGapPreConfigToReleaseList-r17 ::= SEQUENCE (SIZE
(1 . . . maxNrofPreConfigPosGapID-r17)) OF MeasPosPreConfigGapId-r17
PosGapConfig-r17 ::= SEQUENCE {
  measPosPreConfigGapId-r17 MeasPosPreConfigGapId-r17,
  gapOffset-r17 INTEGER (0 . . . 159),
  mgl-r17 ENUMERATED {ms20, ms40, ms80, ms160},
  mgta-r17 ENUMERATED 9ms0, ms0dot25, ms0dot5},
  gapType-r17 ENUMERATED {perUE, perFR1, perFR2},
  . . .
}
MeasPosPreConfigGapId-r17 ::= INTEGER (1 . . . maxNrofPreConfigPosGapId-r17)
--TAG-MEASGAPCONFIG-STOP
--ASN1STOP
```

MeasGapConfig field descriptions

gapAssociationPRS
Indicates that PRS measurement is associated with this measurement gap. The
network only includes this field for one per wireless device gap. If concurrent gap
(i.e. one of the gap combination as defined in Table 9.1.8-1 in 3GPP TS 38.133) is
configured and no gap is configured with this field, the PRS measurement is
associated with the gap configured via gapUE, if available.
gapFR1
Indicates measurement gap configuration that applies to FR1 only. In (NG)EN-DC,
gapFR1 cannot be set up by NR RRC (i.e., only LTE RRC can configure FR1
measurement gap). In NE-DC, gapFR1 can only be set up by NR RRC (i.e. LTE
RRC cannot configure FR1 gap). In NR-DC, gapFR1 can only be set up in the
measConfig associated with MCG. gapFR1 can not be configured together with
gapUE. The applicability of the FR1 measurement gap is according to Table
9.1.2-2 and Table 9.1.2-3 in 3GPP TS 38.133.
gapFR2
Indicates measurement gap configuration applies to FR2 only. In (NG)EN-DC or
NE-DC, gapFR2 can only be set up by NR RRC (i.e., LTE RRC cannot configure
FR2 gap). In NR-DC, gapFR2 can only be set up in the measConfig associated
with MCG. gapFR2 cannot be configured together with gapUE. The applicability
of the FR2 measurement gap is according to Table 9.1.2-2 and Table 9.1.2-3 in
3GPP TS 38.133.
gapOffset
Value gapOffset is the gap offset of the gap pattern with MGRP indicated in the
field mgrp. The value range is from 0 to mgrp-1. If ncsgInd-r17 is present, this
offset value refers to the starting point of VIL1 (the visible interruption length
before the ML).
gapAssociationPRS
Indicates that PRS measurement is associated with this measurement gap. The
network only includes this field for one per wireless device gap. If concurrent gap
(i.e. one of the gap combination as defined in Table 9.1.8-1 in 3GPP TS 38.133) is
configured and no gap is configured with this field, the PRS measurement is
associated with the gap configured via gapUE, if available.
gapPriority
Indicates the priority of this measurement gap (see 3GPP TS 38.133, clause FFS).
Value 1 indicates highest priority, value 2 indicates second level priority, and so on.
gapSharing
Indicates the measurement gap sharing scheme that applies to this GapConfig. For
applicability of the different gap sharing schemes, see 3GPP TS 38.133. Value
scheme00 corresponds to scheme “00”, value scheme01 corresponds to scheme
“01”, and so on.
gapToAddModList
A list of measurement gap configuration to be added or modified. If more than one
measurement gap is configured (i.e., concurrent measurement gap as specified in
3gPP TS 38.133, clause 9.1.8), the maximum number of configured measurement
gap is limited by the gap combinations defined in Table 9.1.8-1 in 3GPP TS
38.133. The network configures at most one NCSG or pre-configured
measurement gap for a given gap type. In this version of the specification, the
network configures this field only in NR standalone.
gapToReleaseList
A list of measurement gap configuration to be released.
gapType
Indicates the type of this measurement gap. Value perUE indicates that it is a per
UE measurement gap, value perFR1 indicates that it is an FR1 measurement gap,
and value perFR2 indicates that it is an FR2 measurement gap.
gapAssociationPRS
Indicates that PRS measurement is associated with this measurement gap. The
network only includes this field for one per wireless device gap. If concurrent gap
(i.e. one of the gap combination as defined in Table 9.1.8-1 in 3GPP TS 38.133) is
configured and no gap is configured with this field, the PRS measurement is
associated with the gap configured via gapUE, if available.
gapUE
Indicates measurement gap configuration that applies to all frequencies (FR1 and
FR2). In (NG)EN-DC, gapUE cannot be set up by NR RRC (i.e., only LTE RRC
can configure per UE measurement gap). In NE-DC, gapUE can only be set up by
NR RRC (i.e., LTE RRC cannot configure per UE gap). In NR-DC, gapUE can
only be set up in the measConfig associated with MCG. If gapUE is configured,
then neither gapFR1 nor gapFR2 can be configured. The applicability of the per
wireless device measurement gap is according to Table 9.1.2-2 and Table 9.1.2-3
in 3GPP TS 38.133.
measGapId
The ID of this measurement gap configuration.
mgl
Value mgl is the measurement gap length in ms of the measurement gap. If
ncsgInd-r17 is not present, the measurement gap length is according to in Table
9.1.2-1 in 3GPP TS 38.133. If ncsgInd-r17 is present, this field indicates the
measurement length (ML) in NCSG pattern and is configured according to Table
9.1.2C-1 in 3GPP TS 38.133. Value ms1dot5 corresponds to 1.5 ms, ms3
corresponds to 3 ms and so on. If mgl-r16 is present, wireless device shall ignore
the mgl (without suffix). Value ms1, ms2, and ms5 can only be configured if
ncsgInd is present.
mgrp
Value mgrp is measurement gap repetition period in (ms) of the measurement gap.
The measurement gap repetition period is according to Table 9.1.2-1 in 3GPP TS
38.133.
gapAssociationPRS
Indicates that PRS measurement is associated with this measurement gap. The
network only includes this field for one per wireless device gap. If concurrent gap
(i.e. one of the gap combination as defined in Table 9.1.8-1 in 3GPP TS 38.133) is
configured and no gap is configured with this field, the PRS measurement is
associated with the gap configured via gapUE, if available.
mgta
Value mgta is the measurement gap timing advance in ms. The applicability of the
measurement gap timing advance is according to clause 9.1.2 of 3GPP TS 38.133.
Value ms0 corresponds to 0 ms, ms0dot25 corresponds to 0.25 ms and ms0dot5
corresponds to 0.5 ms. For FR2, the network only configures 0 ms and 0.25 ms. If
ncsgInd is present, value ms0dot25 can not be configured. Value ms0dot75 can
only be configured if ncsgInd is present.
ncsgInd
Indicates that the measurement gap is a NCSG as specified in 3GPP 38.133.
posMeasGapPreConfigToAddModList
List of preconfigured measurement gap for positioning to add and/or modify. All
the gaps configured are associated with the measurement of PRS for RSTD, UE-RxTx
Time Difference, PRS-RSRP and PRS-RSRPP as defined in 3GPP TS 38.215.
posMeasGapPreConfigToReleasList
List of preconfigured measurement gap for positioning to release.
preConfigInd
Indicates whether the measurement gap is a pre-configured measurement gap.
refFR2ServCellAsyncCA
Indicates the FR2 serving cell identifier whose SFN and subframe is used for FR2
gap calculation for this gap pattern with asynchronous CA involving FR2
carrier(s).
refServCellIndicator
Indicates the serving cell whose SFN and subframe are used for gap calculation
for this gap pattern. Value pCell corresponds to the PCell, pSCell corresponds to
the PSCell, and mcg-FR2 corresponds to a serving cell on FR2 frequency in MCG.

| Conditional | |
|---|---|
| Presence | Explanation |
| AsyncCA | This field is mandatory present when configuring |
| | FR2 gap pattern to wireless device in: |
| | (NG)EN-DC or NR SA with asynchronous CA |
| | involving FR2 carrier(s); |
| | NE-DC or NR-DC with asynchronous CA |
| | involving FR2 carrier(s), if the field |
| | refServCellIndicator is set to mcg-FR2. |
| | In case the gap pattern to wireless device in NE-DC |
| | and NR-DC is already configured and the serving |
| | cell used for the gap calculation corresponds to a |
| | serving cell on FR2 frequency in MCG, then the |
| | field is optionally present, need M. Otherwise, |
| | it is absent, Need R. |
| NEDCorNRDC | This field is mandatory present when configuring |
| | gap pattern to wireless device in NE-DC or NR-DC. |
| | In case the gap pattern to wireless device in |
| | NE-DC and NR-DC is already configured, then the |
| | field is absent, need M. Otherwise, it is absent. |
| PRS | This field is optionally present, Need R, when |
| | configuring gap pattern to wireless device for |
| | measurements of DL-PRS configured via LPP |
| | (3GPP TS 37.355). Otherwise, it is absent. |

### Concurrent Gaps

In NR Rel-17, concurrent measurement gap patterns (C-MGP) have been specified in 3GPP standard such as in, for example, 3GPP TS 38.133 v17.6.0. Examples of different C-MGP with respect to the level of overlap between measurement gaps are shown in FIG. 2. RAN4 has identified five scenarios for concurrent gaps as illustrated in FIG. 2. The C-MGP includes at least two simultaneous configured measurement gap patterns (e.g., at least two individual MGP each of the type shown in FIG. 3). C-MGP may also be called concurrent gaps. The at least two MGPs may be configured using the same or different MGP related parameters. For example, MGL, MGRP, etc. for the at least 2 MGPs may be the same or they may be different. The measurement gaps belonging to different MGPs within the C-MGP may or may not overlap or may partially overlap with respect to each other in time.

Referring back to FIG. 2, the scenario in FIG. 2(a) illustrates two fully non-overlapping measurement gap patterns. Although here the measurement gap repetition periods (MGRP) are illustrated as being the same for both measurement gap patterns, this is not a requirement for the scenario to apply. MGRPs can differ between the MGPs, e.g., one MGRP may be 40 ms and the other 40 ms or 80 ms, and the scenario is fulfilled as long as measurement gaps in one MGP never overlaps, partially or fully, with a measurement gap in another MGP. In standardization discussions this scenario is referred to as the fully non-overlapping (FNO) scenario.

The scenarios in FIG. 2(b) illustrate two fully overlapping measurement gap patterns. In either case, one MGP is always contained within the other, and the MGRPs for the two MGPs are the same MGRP. In standardization discussions these scenarios are referred to as fully overlapping (FO) scenarios.

The scenario in FIG. 2(c) illustrates two measurement gap patterns that whose gaps consistently partially overlap each other. The MGRPs are the same MGRP. In the standardization discussions this scenario is referred to as the fully-partial overlapped (FPO) scenario.

The scenario in FIG. 2(d) illustrates two measurement gap patterns that at least occasionally fully overlap each other. For this scenario to apply, the MGRPs have to be different, e.g., one MGRP 40 ms and the other MGRP 80 ms. In the standard this scenario is referred to as the partially-fully overlapped (PFO) scenario.

The scenario in FIG. 2(e) illustrates two measurement gap patterns whose gaps at least occasionally partially overlap each other. For this scenario to apply, the MGRPs for the two measurement gap patterns have to be different, e.g., one MGRP is 40 ms and the other MGRP is 80 ms. In the standardization discussion this scenario is referred to as the partially-partial overlapped (PPO) scenario.

### Pre-Configured Gaps

Pre-configured measurement gaps (Pre-MG) have also been specified as part of the 3GPP Rel-17 Measurement Gaps enhancement work item (WU). The intention of the work item is to allow the configuration of “deactivated” measurement gaps, i.e., the wireless device only uses the configured gaps to perform measurements under certain situations. Hence the term “pre-configured”. This differs from legacy measurement gaps, since for this new case, the gap is not automatically setup (“activated”) upon configuration.

Two methods have been specified for the activation/deactivation of the so called pre-configured measurement gaps: a) autonomous approach and b) network-controlled mechanism. For the first case, the wireless device can autonomously discriminate whether there is a need to use the pre-configured gap to perform measurements (e.g., if upon BWP switching the reference signal is not completely contained within the new active BWP). While for the latter approach, the network/network node explicitly indicates in each BWP configuration whether the pre-configured gap should be activated/deactivated upon switching to this particular BWP. The one or more gaps which are not used for the measurement (e.g., SSB to be measured is within the wireless device's active BWP) are considered to be ‘deactivated’ or the status of Pre-MG is set to ‘deactivation’. The one or more gaps which are used for the measurement (e.g., SSB to be measured is NOT within the wireless device's active BWP) are considered to be ‘activated’ or the status of Pre-MG is set to ‘activation’. The wireless device can be scheduled with data in DL and/or in UL by the network node during the deactivated gaps in the serving cell, i.e., when the status of Pre-MG is deactivated. The wireless device is not expected to receive any data from or transmit any data to the base station during the activated gaps in the serving cell, i.e., when the status of Pre-MG is activated. An example of Pre-MG is illustrated in previously referred to FIG. 3.

### NR Network Control Small Gap (NCSG) and NCSG Patterns

NCSG based measurement and NCSG patterns are defined in 3GPP standard such as in, for example, 3GPP TS38.133 v17.6.0. The wireless device capable of network controlled small gap (NCGG) pattern can be configured with a NCSG pattern via RRC signaling. The wireless device supports NCSG patterns defined in Table 3 that are relevant to the wireless device's measurement capabilities. ML is the measurement length. During the VIL1 and VIL2, the wireless device is not expected to transmit and receive any data. Where, VIL1 is the visible interruption length before the ML and VIL2 is the visible interruption length after the ML. During ML, whether the wireless device 22 is expected to transmit and receive data on the corresponding serving carrier(s) depends on the scheduling restriction. The NCSG configuration parameters VIL1, ML, VIL2 and VIRP are illustrated in the timing diagram of FIG. 4.

TABLE 3
NCSG Configurations supported by the wireless device

| NCSG | Measurement Length | Visible interruption |
|---|---|---|
| Pattern | during which there | Repetition Period |
| Id | is no gap (ML, ms) | (VIRP, ms) |
| 0 | 5 | 40 |
| 1 | 5 | 80 |
| 2 | 2 | 40 |
| 3 | 2 | 80 |
| 4 | 5 | 20 |
| 5 | 5 | 160 |
| 6 | 3 | 20 |
| 7 | 3 | 40 |
| 8 | 3 | 80 |
| 9 | 3 | 160 |
| 10 | 2 | 20 |
| 11 | 2 | 160 |
| 12 | 5 | 20 |
| 13 | 5 | 40 |
| 14 | 5 | 80 |
| 15 | 5 | 160 |
| 16 | 3 | 20 |
| 17 | 3 | 40 |
| 18 | 3 | 80 |
| 19 | 3 | 160 |
| 20 | 1 | 20 |
| 21 | 1 | 40 |
| 22 | 1 | 80 |
| 23 | 1 | 160 |

The wireless device's behavior after network/network node configuring NCSG and MG is illustrated in FIG. 5.

### NR NeedForGaps Capability

In 3GPP Rel-16 (Rel-16), RAN2 introduced the NeedForGap feature, which points towards a more “dynamic” gap reporting approach. It generally works as follows:
in a first (RRC) reconfiguration message, the network node configures the wireless device with serving cell(s) and/or SCG (i.e., frequencies on which to operate) and a list of target bands on which the wireless device could potentially measure,
the wireless device then indicates (in the RRCReconfigurationComplete message) for which target frequency bands gaps are actually needed, and
finally, in a second RRCReconfiguration message the network node configures the measurement gaps needed by the wireless device.

For this case then, the wireless device-based signalling procedure allows for “no gaps” to be configured for certain bands.

Note that the NeedForGap “capability” in each targeted frequency band (second bullet above), is not actually part of the wireless device capability signalling but as depicted by the aforementioned description, it is rather an indication embedded into the RRCReconfiguration procedure that allows the wireless device to report to the network/network node on which bands there is a need (or no need) to configure gaps to perform measurements. This can be depicted in the following information element, as taken from 3GPP standards such as, for example, from 3GPP TS 38.331 v17.1.0:

### NeedForGapsInfoNR

The IE NeedForGapsInfoNR indicates whether measurement gap is required for the wireless device to perform SSB based measurements on an NR target band while NR-DC or NE-DC is not configured.

### NeedForGapsInfoNR Information Element

```
-- ASN1START
-- TAG-NeedForGapsInfoNR-START
NeedForGapsInfoNR-r16 ::= SEQUENCE
  intraFreq-needForGap-r16 NeedForGapsIntraFreqList-r16,
  interFreq-needForGap-r16 NeedForGapsBandListNR-r16
}
NeedForGapsIntraFreqList-r16 ::= SEQUENCE (SIZE (1 . . .
maxNrofServingCells)) OF NeedForGapsIntraFreq-r16
NeedForGapsBandListNR-r16 ::= SEQUENCE (SIZE (1 . . . maxBands)) OF
NeedForGapsNR-r16
NeedForGapsIntraFreq-r16 ::= SEQUENCE {
  servCellId-r16 ServCellIndex,
  gapIndicationIntra-r16 ENUMERATED {gap, no-gap}
}
NeedForGapsNR-r16 ::= SEQUENCE {
  bandNR-r16 FreqBandIndicatorNR,
  gapIndication-r16 ENUMERATED {gap, no-gap}
}
-- TAG-NeedForGapsInfoNR-STOP
-- ASN1STOP
```

NeedForGapsInfoNR field descriptions

intraFreq-needForGap
Indicates the measurement gap requirement information for NR
intra-frequency measurement.
interFreq-needForGap
Indicates the measurement gap requirement information for NR
inter-frequency measurement.

NeedForGapsIntraFreq field descriptions

servCellId
Indicates the serving cell which contains the target SSB (associated
with the initial DL BWP) to be measured.
gapIndicationIntra
Indicates whether measurement gap is required for the wireless device
to perform intra-frequency SSB based measurements on the concerned
serving cell. Value gap indicates that a measurement gap is needed if
any of the wireless device configured BWPs do not contain the
frequency domain resources of the SSB associated to the initial DL
BWP. Value no-gap indicates a measurement gap is not needed to
measure the SSB associated to the initial DL BWP for all configured
BWPs, no matter the SSB is within the configured BWP or not.

NeedForGapsNR field descriptions

bandNR
Indicates the NR target band to be measured.
gapIndication
Indicates whether measurement gap is required for the wireless device to
perform SSB based measurements on the concerned NR target band while
NR-DC or NE-DC is not configured. The wireless device determines this
information based on the resultant configuration of the
RRCReconfiguration or RRCResume message that triggers this response.
Value gap indicates that a measurement gap is needed, value no-gap
indicates a measurement gap is not needed.

Above it may be observed that for each band, ‘gap’ or ‘no-gap’ could be indicated/reported by the wireless device, according to the information that the network/network node has already provided in a first RRCReconfiguration message.

As for the actual wireless device capability signaling, Rel-16 wireless device supporting the NeedForGap procedure would indicate this to the network/network node by using the following single wireless device capability related to the reporting mechanism, as found in 3GPP standard such as in, for example, 3GPP TS 38.306:

| | | | | |
|---|---|---|---|---|
| nr-NeedForGap-Reporting-r16 | Wireless | No | No | No |
| Indicates whether the wireless device | device | | | |
| supports reporting the measurement gap | | | | |
| requirement information for NR target in | | | | |
| the wireless device response to a network | | | | |
| configuration RRC message. | | | | |

### NR NCSG Reporting and Wireless Device Capability

RAN2 agreed to mimic the NeedForGap reporting mechanism for Rel-17's NCSG (i.e., using RRCReconfiguration messages), while adding the ‘nogap-noncsg’ indication. This can be observed in the following element, as taken 3GPP standards such as, for example, from 3GPP TS 38.331:

### NeedForGapNCSG-InfoNR

The IE NeedForGapNCSG-InfoNR indicates whether measurement gap or NCSG is required for the wireless device to perform SSB based measurements on an NR target band while NR-DC or NE-DC is not configured.

### NeedForGapNCSG-InfoNR Information Element

```
-- ASN1START
-- TAG-NEEDFORGAPNCSG-INFONR-START
NeedForGapNCSG-InfoNR-r17 ::= SEQUENCE {
  intraFreq-needForNCSG-r17 NeedForNCSG-IntraFreqList-r17,
  interFreq-needForNCSG-r17 NeedForNCSG-BandListNR-r17
}
NeedForNCSG-IntraFreqList-r17 ::= SEQUENCE (SIZE (1 . . . maxNrofServingCells))
OF NeedForNCSG-IntraFreq-r17
NeedForNCSG-BandListNR-r17 ::= SEQUENCE (SIZE (1 . . . maxBands)) OF
NeedForNCSG-NR-r17
NeedForNCSG-IntraFreq-r17 ::= SEQUENCE {
  servCellId-r17 ServCellIndex,
  gapIndication Intra-r17 ENUMERATED {gap, ncsg, nogap-noncsg}
}
NeedForNCSG-NR-r17 ::= SEQUENCE {
  bandNR-r17 FreqBandIndicatorNR,
  gapIndication-r17 ENUMERATED {gap, nesg, nogap-noncsg}
}
-- TAG-NEEDFORGAPNCSG-INFONR-STOP
-- ASN1STOP
```

NeedForGapNCSG-InfoNR field descriptions

intraFreq-needForNCSG
Indicates the measurement gap and NCSG requirement information for NR
intra-frequency measurement.
interFreq-needForNCSG
Indicates the measurement gap and NCSG requirement information for NR
inter-frequency measurement.

NeedForNCSG-IntraFreq field descriptions

servCellId
Indicates the serving cell which contains the target SSB (associated with
the initial DL BWP) to be measured.
gapIndicationIntra
Indicates whether measurement gap or NCSG is required for the wireless
device to perform intra-frequency SSB based measurements on the
concerned serving cell. Value gap indicates that a measurement gap is
needed if any of the UE configured BWPs do not contain the frequency
domain resources of the SSB associated to the initial DL BWP. Value ncsg
indicates that a NCSG is needed if any of the UE configured BWPs do not
contain the frequency domain resources of the SSB associated to the initial
DL BWP. Value nogap-noncsg indicates that neither a measurement gap
nor a NCSG is needed to measure the SSB associated to the initial DL
BWP for all configured BWPs, no matter the SSB is within the
configured BWP or not.

NeedForNCSG-NR field descriptions

bandNR
Indicates the NR target band to be measured.
gapIndication
Indicates whether measurement gap or NCSG is required for the wireless
device to perform SSB based measurements on the concerned NR target
band while NR-DC or NE-DC is not configured. The wireless device
determines this information based on the resultant configuration of the
RRCReconfiguration or RRCResume message that triggers this response.
Value gap indicates that a measurement gap is needed, value ncsg
indicates that a NCSG is needed, and value nogap-noncsg indicates
neither a measurement gap nor a NCSG is needed.

However, for Rel-17's NCSG, wireless devices can instead indicate to the network/network node two types of wireless device capabilities:
1. Whether the wireless device supports the “NeedForGap-like NCSG reporting” (i.e., using the dynamic approach mentioned before), and/or
2. Whether the wireless device supports the NCSG gap patterns.

This can be observed by the following NR-scenario-related wireless device capabilities taken from 3GPP standard such as, for example, 3GPP TS 38.306:

| | | | | |
|---|---|---|---|---|
| nr-NeedForGapNCSG-reporting-r17 | WD | No | No | No |
| Indicates whether the wireless device supports | | | | |
| reporting of the NCSG and measurement gap | | | | |
| requirement information for SSB based | | | | |
| measurement in the wireless device response | | | | |
| to a network configuration RRC message as | | | | |
| specified in 3GPP TS 38.331. | | | | |
| ncsg-MeasGapNR-Patterns-r17 | WD | No | No | No |
| Indicates whether the wireless device | | | | |
| supports NR-only NCSG patterns. The left | | | | |
| most bit in the bitmap corresponds to NCSG | | | | |
| pattern #0 and the right most bit in the | | | | |
| bitmap corresponds to NCSG pattern #23. A | | | | |
| bit in the bitmap is set to 1 if the | | | | |
| corresponding pattern is supported by the | | | | |
| UE. NCSG patterns #0 to #23 are as | | | | |
| specified in 3GPP standard, such as, for | | | | |
| example, in 3GPP TS38.133. | | | | |
| NCSG patterns #2 and #3 are mandatory (i.e., | | | | |
| the corresponding bits in the bitmap is set to | | | | |
| 1) if the wireless device includes this field. | | | | |
| NCSG patterns #17 and #18 are mandatory | | | | |
| (i.e., the corresponding bits in the bitmap is | | | | |
| set to 1) if wireless device includes this field | | | | |
| and supports a FR2 band. Wireless devices | | | | |
| supporting this shall indicate support of | | | | |
| nr-NeedForGapNCSG-reporting-r17. | | | | |

If a wireless device supports the NCSG reporting, but not the patterns, then the wireless device is not supposed to indicate ‘ncsg’ in a targeted band. But, it can only report ‘nogap-noncsg’ or ‘gap’ accordingly.

### Dynamic Spectrum Sharing (DSS) and CRS-IM

Dynamic Spectrum Sharing is known as DSS or LTE-NR co-existence. Spectrum sharing enables flexible partitioning of resources between NR and LTE with a limited impact on LTE capacity.

There may be CRS inference in an overlapping spectrum for LTE and NR.

Two example scenarios may be considered:
Scenario 1: Both serving and neighbor cells are operated in DSS (NR+LTE) mode.
Scenario 2: The serving cell is operated in NR mode and the neighbor cell is operated in LTE mode.

Some features, including rate-matching on LTE CRS and CRS-IM receiver are introduced to relief the interference from CRS to NR PDSCH signals within serving cell operating in DSS mode.

### Scheduling Restriction

The scheduling restriction is used in the scenarios in which the wireless device can perform measurement without gaps in NR. Examples of such measurements are SSB based intra-frequency or inter-frequency measurements without measurement gaps when the reference signals (e.g., SSB) used for measurements are fully within the bandwidth of the active BWP of the wireless device. In another example, intra-frequency, inter-frequency or inter-RAT measurements can be performed without gaps if the wireless device has an extra or spare receiver chain which in turn can be used for measurements. However, during the resources containing the reference signals (e.g., SSB, CSI-RS, etc.) used for measurements, there can be scheduling restrictions. The scheduling restriction implies that at least during the resources containing the reference signals used for measurements as well X1 number of symbols before and X2 number of symbols after these measurement reference signals, the wireless device may be not expected to transmit or receive any signal in the serving cell based on some specific conditions. For example, the received data and measured SSB are mix numerology in FR1 or received data and measured SSB are intra-frequency or inter-frequency with common beam management (CBM) in FR2.

In some scenarios, the wireless device is not even expected to transmit or receive any signal in the serving cell during the resources containing the reference signals used for measurements as well X3 number of symbols before and X4 number of symbols after these measurement resources.

The wireless device supporting NCSG or NeedForGaps will report to a network node indicating whether a gap (e.g., measurement gap) is needed or not in each band for performing measurements. However, no wireless device behavior is defined when the wireless device supports/capability is directed to no gap for performing measurements in cells operating on a E-UTRA band. Especially, in existing network deployment, DSS technology has widely been deployed in the real field. However, no clear wireless device behavior is defined if the wireless device supports inter-RAT E-UTRA measurement without gap, including the scheduling restriction, measurement delay, etc. Hence, existing network deployments with respect to measurement gap(s) are not without issues.

### SUMMARY

Some embodiments advantageously provide methods, systems, and apparatuses for inter-radio access technology (RAT) measurement without measurement gaps.

According to a first aspect, there are provided embodiments of a method implemented by a wireless device. The wireless device is configured to communicate with a network node. The method comprises receiving a configuration for inter-radio access technology (RAT) measurement without measurement gaps. The configuration defines an effective measurement window for performing inter-RAT measurement without measurement gaps. The method comprises performing inter-RAT measurement without measurement gaps in the effective measurement window on at least one cell based on the configuration.

Corresponding embodiments of a wireless device are also provided.

According to a second aspect, there are provided embodiments of a method implemented by a network node. The network node is configured to communicate with a wireless device. The method comprises determining a configuration for the wireless device to perform inter-radio access technology (RAT) measurement without measurement gaps. The configuration defines an effective measurement window for performing inter-RAT measurement without measurement gaps. The method comprises causing transmission of the configuration to the wireless device.

Corresponding embodiments of a network node are also provided.

One or more embodiments of the present disclosure provide methods for a wireless device and a network node to assess and perform measurement procedure on cells of an inter-RAT carrier frequency (e.g., inter-RAT EUTRAN cell(s)) (e.g., measurement rate, periodicity, time etc.) based on wireless device's capability and network's configuration.

The wireless device's measurement behavior may for example be defined if the wireless device supports inter-RAT measurement (e.g., inter-RAT EUTRAN measurement, etc.) without gap, including scheduling restriction, and measurement delay.

According to an embodiment, the wireless device indicates that it supports inter-RAT measurement (e.g., inter-RAT EUTRAN measurement) without gap with respect to reporting ‘nogap-noncsg’ for an inter-RAT band (e.g., E-UTRA band) in a NCSG reporting when the wireless device supports NCSG capability.

According to another embodiment, the wireless device indicates that it supports inter-RAT measurement (e.g., inter-RAT EUTRAN measurement) without gap with respect to reporting ‘no-gap’ for an inter-RAT band (e.g., E-UTRA band) in a NeedForGaps reporting when the wireless device supports NeedForGaps capability.

According to another embodiment, the wireless device indicates that it supports inter-RAT measurement (e.g., inter-RAT EUTRAN measurement) without gap with respect to corresponding capability indicated. In one aspect of the embodiment, the solution is valid or applicable provided that the bandwidth (BW) of a reference signal (RS) in a target inter-RAT cell (e.g., EUTRAN cell's CRS BW) is fully within the BW of the active BWP of the serving NR cell.

Another aspect of the embodiment is that the wireless device capable of inter-RAT measurement (e.g., inter-RAT EUTRAN measurement) without gap does not need to perform the inter-RAT measurement (e.g., inter-RAT EUTRAN measurement) within gap.

Another aspect of the embodiment is that the wireless device capable of inter-RAT measurement (e.g., inter-RAT EUTRAN measurement) without gap, the inter-RAT measurement delay (e.g., inter-RAT EUTRAN measurement delay) is adapted (e.g., extended or shortened) based on a number of inter-RAT frequency layers (e.g., E-UTRAN frequency layers) on which the wireless device indicates that it can perform the inter-RAT measurement (e.g., inter-RAT EUTRAN measurement) without gap during an effective measurement window (EMW). The EMW is obtained or determined based on one or more rules, which can be pre-defined and/or configured by a network node.

Another aspect of the embodiment is that for the wireless device capable of inter-RAT measurement (e.g., inter-RAT EUTRAN measurement) without gap, the scheduling restriction while performing intra-band inter-RAT measurement (e.g., intra-band EUTRAN measurement) is defined or applicable based on a RS (e.g., CRS symbols) received in the EMW.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of an example of a measurement gap pattern in NR;

FIG. 2 is a diagram of examples of scenarios for concurrent measurement gap patterns;

FIG. 3 is a diagram of an example of pre-configured measurement gap pattern in NR;

FIG. 4 is a diagram of an example NCSG configuration parameters: VIL1, ML, VIL2 and VIRP;

FIG. 5 is a diagram of wireless device behavior after NW configuration NCSG and MG;

FIG. 6 is a schematic diagram of an exemplary network architecture illustrating a communication system connected via an intermediate network to a host computer according to the principles in the present disclosure;

FIG. 7 is a block diagram of a host computer communicating via a network node with a wireless device over an at least partially wireless connection according to some embodiments of the present disclosure;

FIG. 8 is a flowchart illustrating exemplary methods implemented in a communication system including a host computer, a network node and a wireless device for executing a client application at a wireless device according to some embodiments of the present disclosure;

FIG. 9 is a flowchart illustrating exemplary methods implemented in a communication system including a host computer, a network node and a wireless device for receiving user data at a wireless device according to some embodiments of the present disclosure;

FIG. 10 is a flowchart illustrating exemplary methods implemented in a communication system including a host computer, a network node and a wireless device for receiving user data from the wireless device at a host computer according to some embodiments of the present disclosure;

FIG. 11 is a flowchart illustrating exemplary methods implemented in a communication system including a host computer, a network node and a wireless device for receiving user data at a host computer according to some embodiments of the present disclosure;

FIG. 12 is a flowchart of an exemplary process in a network node according to some embodiments of the present disclosure;

FIG. 13 is a flowchart of an exemplary process in a wireless device according to some embodiments of the present disclosure; and

FIG. 14 is a diagram of CSSFoutside gap.

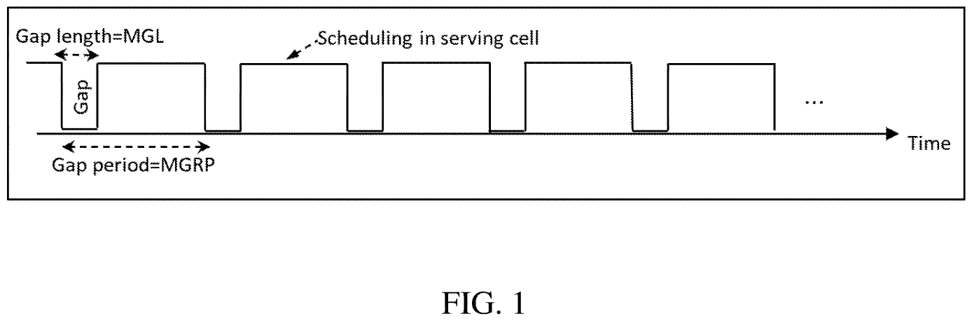

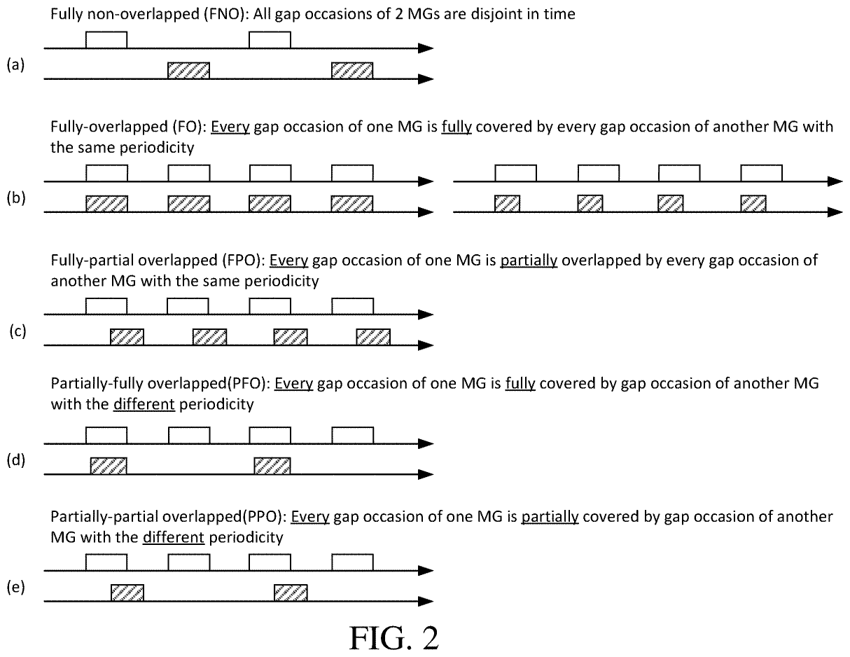

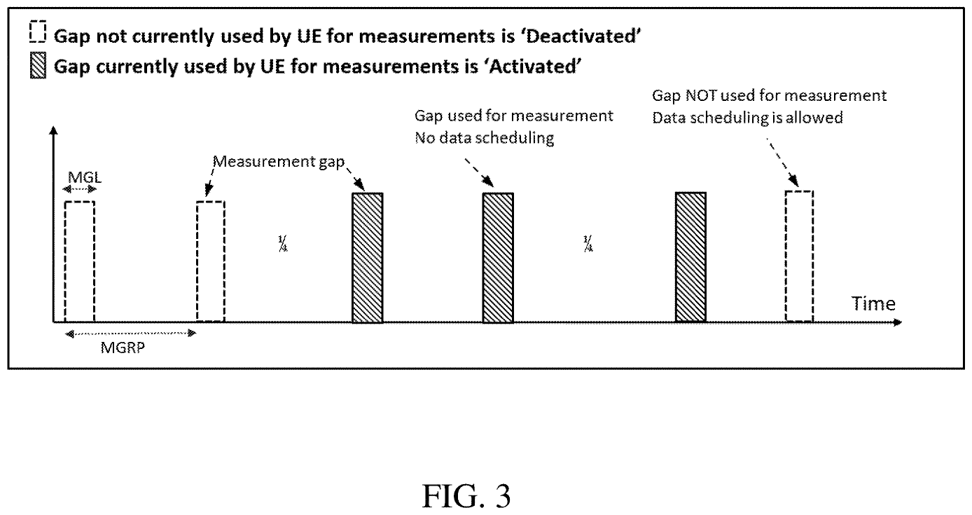

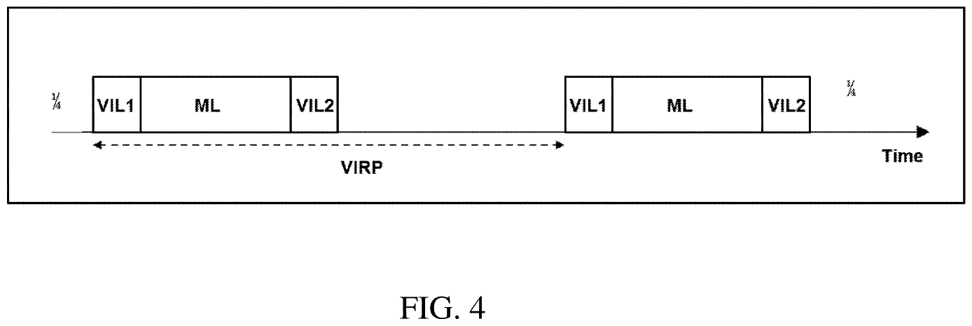

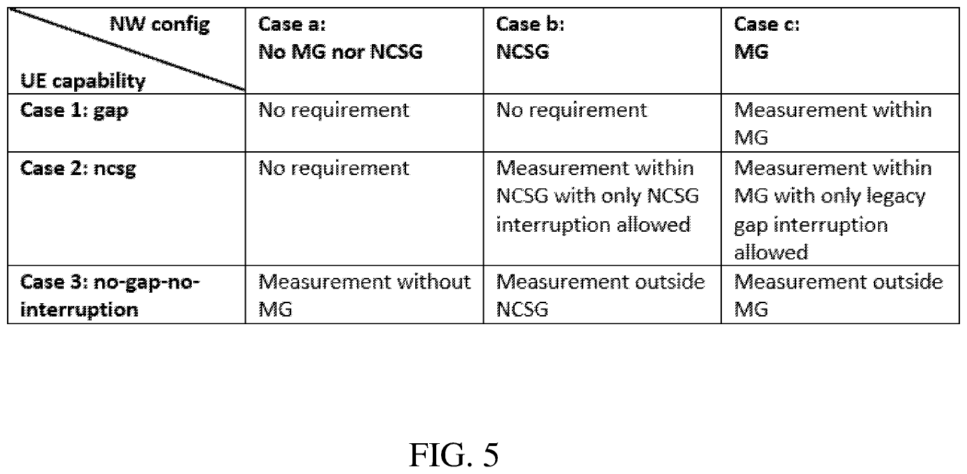

### DETAILED DESCRIPTION

As described above, there is a lack of defined wireless device behavior when the wireless device supports no gap for performing measurements on cells operating on a E-UTRA band. That is, there is no defined wireless device behavior if the wireless device supports inter-RAT E-UTRA measurement without gap, including the scheduling restriction, measurement delay, etc. One possible solution may require the network/network node to always configure gaps for inter-RAT E-UTRA measurement causing interruption/loss of data on NR serving cells. This, in turn, degrades the NR performance, e.g., user throughput loss, reduction in the user bit rate, etc.

One or more embodiments described herein provides one or more solutions to existing problems such as the problems noted above. That is, one or more embodiments provide method(s) and behavior for a wireless device and a network node to perform configurations and/or measurements with respect to Inter-RAT EUTRAN measurement without gap.

Before describing in detail exemplary embodiments, it is noted that the embodiments reside primarily in combinations of apparatus components and processing steps related to inter-radio access technology (RAT) measurement without measurement gaps. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

Some additional examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME etc), O&M, OSS, SON, positioning node (e.g. E-SMLC), etc.

In some embodiments, the non-limiting terms wireless device (WD) or a user equipment (UE) are used interchangeably. The WD herein can be any type of wireless device capable of communicating with a network node or another WD over radio signals, such as wireless device (WD) and/or using cellular or mobile communication systems. The WD may also be a radio communication device, target device, device to device (D2D) WD, vehicular to vehicular (V2V), machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, 6G, future generation RAT etc. Any of the equipment denoted by the term node, network node or radio network node may be capable of supporting a single or multiple RATs

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The term signal or radio signal used herein can be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with respect to reference time (e.g. serving cell's SFN) etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information e.g. data, control etc. Examples of physical channels are PBCH, NPBCH, PDCCH, PDSCH, sPUCCH, SPDSCH. sPUCCH. sPUSCH, MPDCCH, NPDCCH, NPDSCH, E-PDCCH, PUSCH, PUCCH, NPUSCH etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, etc.

The term inter-RAT band may refer to a frequency band on whose cells the wireless device can perform the inter-RAT measurement without gaps.

The term intra-band inter-RAT measurement may refer to an inter-RAT measurement performed on an inter-RAT carrier frequency, which is in the intra-band which contains the carrier frequency of at least one serving carrier frequency.

The term inter-band inter-RAT measurement may refer to an inter-RAT measurement performed on an inter-RAT carrier frequency, which is in the inter-band of the band which contains the carrier frequency of at least one serving carrier frequency.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide inter-RAT measurement without measurement gaps.

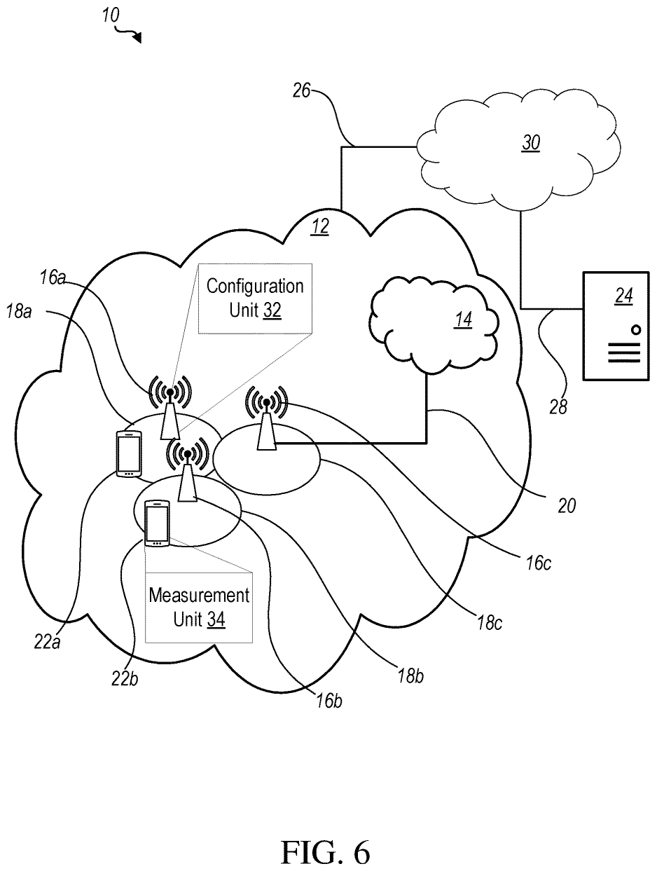

Referring again to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to perform one or more network node 16 functions as described herein such as with respect to inter-RAT measurement without measurement gaps. A wireless device 22 is configured to include a measurement unit 34 which is configured to perform one or more wireless device 22 functions as described herein such as with respect to inter-RAT measurement without measurement gaps.

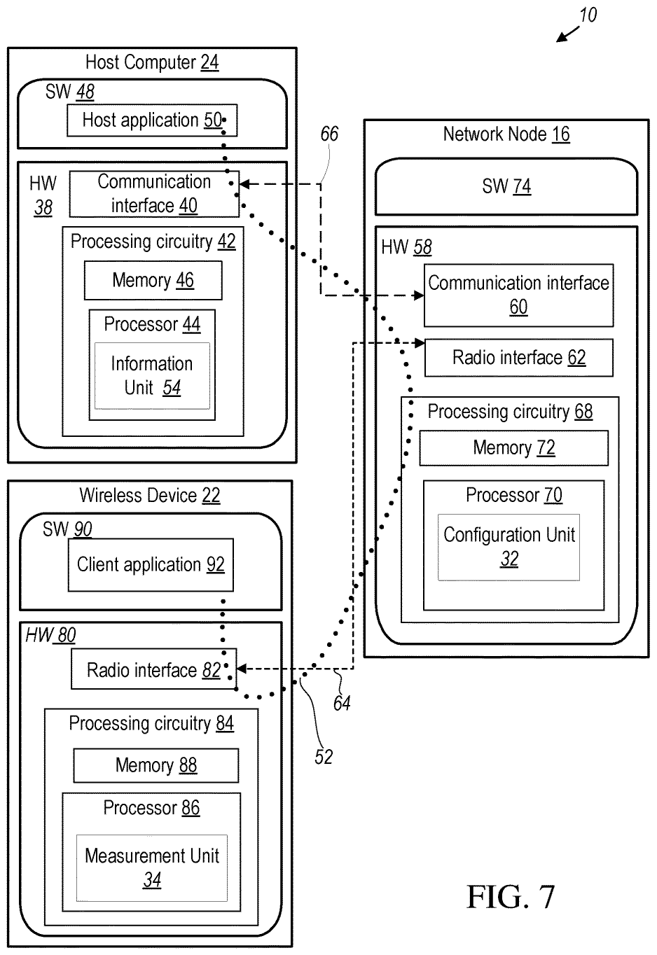

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to determine, analyze, store, forward, receive, relay, transmit, communication, signal, etc. information associated with inter-RAT measurement without measurement gaps.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform one or more network node 16 functions as described herein such as with respect to inter-RAT measurement without measurement gaps.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a measurement unit 34 configured to perform one or more wireless device 22 functions as described herein such as with respect to inter-RAT measurement without measurement gaps.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as configuration unit 32, and measurement unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

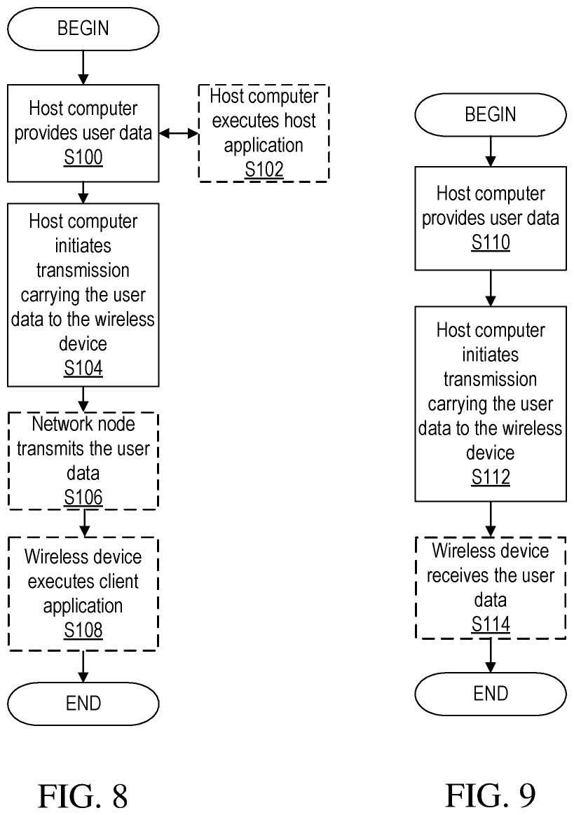

FIG. 8 is a flowchart illustrating an exemplary method implemented in a communication system, such as, for example, the communication system of FIGS. 6 and 7, in accordance with one embodiment. The communication system may include a host computer 24, a network node 16 and a WD 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 9 is a flowchart illustrating an exemplary method implemented in a communication system, such as, for example, the communication system of FIG. 6, in accordance with one embodiment. The communication system may include a host computer 24, a network node 16 and a WD 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

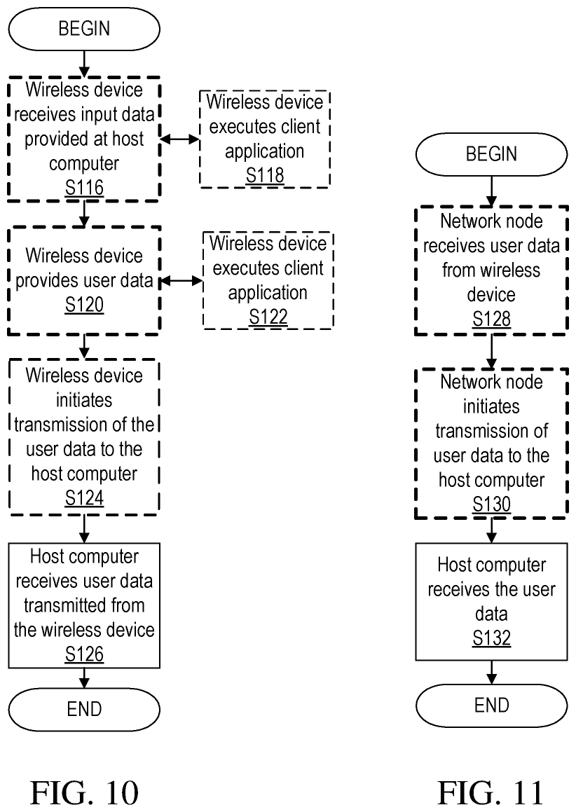

FIG. 10 is a flowchart illustrating an exemplary method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 11 is a flowchart illustrating an exemplary method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

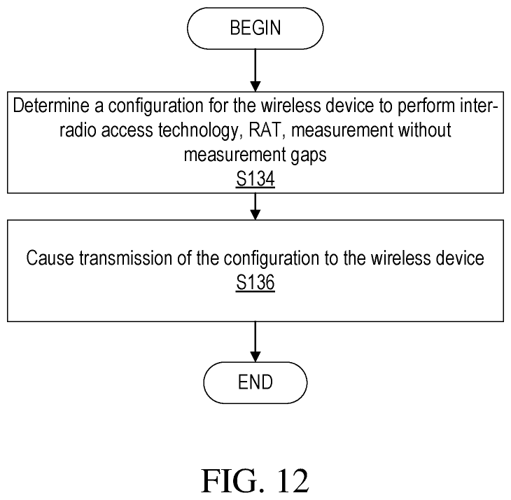

FIG. 12 is a flowchart of an exemplary process in a network node 16 according to some embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to determine (Block S134) a configuration for the wireless device 22 to perform inter-radio access technology, RAT, measurement without measurement gaps, as described herein. Network node 16 is configured to cause (Block S136) transmission of the configuration to the wireless device 22, as described herein.

According to one or more embodiments, the configuration is based on at least one scheduling configuration, the at least one scheduling configuration including at least one of: no scheduling restriction for uplink control channel and shared channel transmission and downlink control channel and shared channel reception for channel quality indicator, CQI, reception based on the wireless device supporting inter-RAT measurement without measurement gaps; no scheduling restriction for uplink control channel and shared channel transmission and downlink control channel and shared channel reception for CQI reception based on the wireless device supporting inter-RAT measurement without measurement gaps and frequency layers are inter-band; the wireless device is not expected to transmit on an uplink control channel and shared channel and receive on a downlink control channel and shared channel for CQI on inter-RAT reference signal symbols configured to be measured and on a data symbol before and after each reference signal symbol configured within an inter-RAT measurement window duration; the wireless device is not expected to transmit on an uplink control channel and shared channel and receive on a downlink control channel and shared channel for CQI on inter-RAT RSSI measurement symbols configured to be measured and on a data symbol before and after each reference signal symbol configured within an inter-RAT measurement window duration; and the wireless device is not expected to transmit on an uplink control channel and shared channel and receive on a downlink control channel and shared channel for CQI on all symbols within an inter-RAT measurement window duration.

According to one or more embodiments, the configuration defines an effective measurement window, EMW, for performing inter-RAT measurement, the EMW being based on at least one of: a configured measurement gap pattern; a configured reference signal configuration; a predefined configuration defining a periodicity and offset of the EMW; information signaled in radio resource control, RRC, signaling; and a number of carriers configured for performing measurements without gaps.

According to one or more embodiments, the configuration defines a measurement time for performing inter-RAT measurements, the measurement time being based on at least one of: one of a cell identification period and physical layer measurement period of an identified cell; a detectable frequency division duplex, FDD/time division duplex, TDD, cell within a cell identification period; and a number of frequency layers for inter-RAT measurement without measurement gaps.

According to one or more embodiments, the configuration is based on network controlled small gap pattern, NCSG, capability of the wireless device 22 and network node 16.

According to one or more embodiments, the configuration is based on a dynamic spectrum sharing, DSS, capability of the wireless device 22 and network node 16.

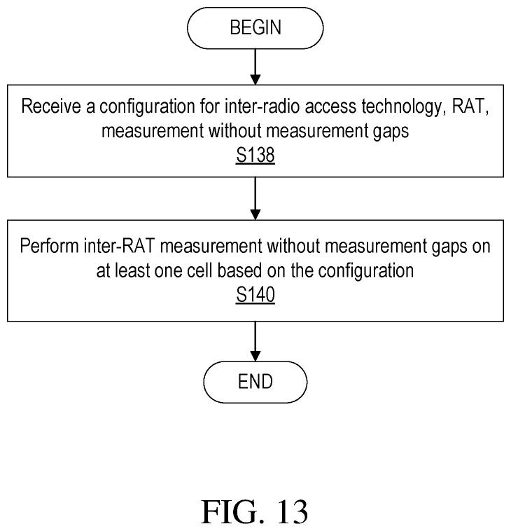

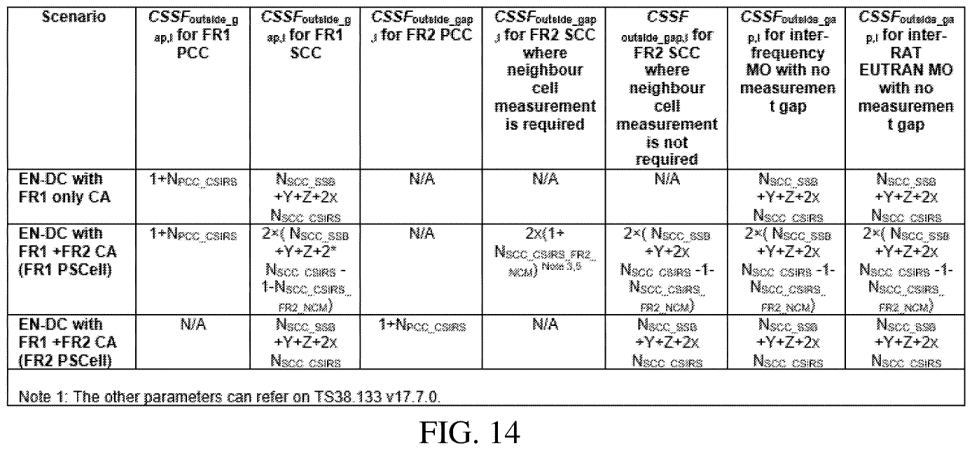

FIG. 13 is a flowchart of an exemplary process in a wireless device 22 according to some embodiments of the present disclosure. One or more blocks described herein may be performed by one or more elements of wireless device 22 such as by one or more of processing circuitry 84 (including the measurement unit 34), processor 86, radio interface 82 and/or communication interface 60. Wireless device 22 is configured to receive (Block S138) a configuration for inter-radio access technology, RAT, measurement without measurement gaps, as described herein. Wireless device 22 is configured to perform inter-RAT measurement without measurement gaps on at least one cell based on the configuration.

According to one or more embodiments, the configuration is based on at least one scheduling configuration, the at least one scheduling configuration including at least one of: no scheduling restriction for uplink control channel and shared channel transmission and downlink control channel and shared channel reception for channel quality indicator, CQI, reception based on the wireless device supporting inter-RAT measurement without measurement gaps; no scheduling restriction for uplink control channel and shared channel transmission and downlink control channel and shared channel reception for CQI reception based on the wireless device supporting inter-RAT measurement without measurement gaps and frequency layers are inter-band; the wireless device is not expected to transmit on an uplink control channel and shared channel and receive on a downlink control channel and shared channel for CQI on inter-RAT reference signal symbols configured to be measured and on a data symbol before and after each reference signal symbol configured within an inter-RAT measurement window duration; the wireless device is not expected to transmit on an uplink control channel and shared channel and receive on a downlink control channel and shared channel for CQI on inter-RAT RSSI measurement symbols configured to be measured and on a data symbol before and after each reference signal symbol configured within an inter-RAT measurement window duration; and the wireless device is not expected to transmit on an uplink control channel and shared channel and receive on a downlink control channel and shared channel for CQI on all symbols within an inter-RAT measurement window duration.

According to one or more embodiments, the configuration defines an effective measurement window, EMW, for performing inter-RAT measurement, the EMW being based on at least one of: a configured measurement gap pattern; a configured reference signal configuration; a predefined configuration defining a periodicity and offset of the EMW; information signaled in radio resource control, RRC, signaling; and a number of carriers configured for performing measurements without gaps.

According to one or more embodiments, the configuration defines a measurement time for performing inter-RAT measurements, the measurement time being based on at least one of: one of a cell identification period and physical layer measurement period of an identified cell; a detectable frequency division duplex, FDD/time division duplex, TDD, cell within a cell identification period; and a number of frequency layers for inter-RAT measurement without measurement gaps.

According to one or more embodiments, the configuration is based on network controlled small gap pattern, NCSG, capability of the wireless device 22 and network node 16.

According to one or more embodiments, the configuration is based on a dynamic spectrum sharing, DSS, capability of the wireless device 22 and network node 16.

Having described the general process flow of arrangements of the disclosure and having provided examples of hardware and software arrangements for implementing the processes and functions of the disclosure, the sections below provide details and examples of arrangements for inter-RAT measurement without measurement gaps.

Some embodiments provide inter-RAT measurement without measurement gaps. One or more wireless device 22 functions described below may be performed by one or more of processing circuitry 84, processor 86, measurement unit 34, radio interface 82, etc. One or more network node 16 functions described below may be performed by one or more of processing circuitry 68, processor 70, configuration unit 32, radio interface 62, etc.

### Scenario Description

The scenario includes at least one wireless device 22 which is operating in a first cell 18 (e.g., cell1) served by a network node 16 (e.g., NW1), and performing measurements on one or more serving cell(s) and one or more neighbor cells or neighbor frequencies, e.g., on serving carrier and/or one or more additional carriers configured for performing measurements. Any additional carrier may belong to the RAT of the serving carrier frequency. In this case, if that carrier is a non-serving carrier, then it is called as inter-frequency carrier. The additional carrier may also belong to another RAT and in which case it is called as inter-RAT carrier. The term carrier may also interchangeably be called as carrier frequency, layer, frequency layer, carrier frequency layer etc. For consistency term carrier is used herein after.

In general, the wireless device 22 is served by a cell operating on a first carrier frequency (F11) belonging to a first RAT (RAT1) and is further configured to perform a measurement on one or more cells operating on a second carrier frequency (F21) belonging to a second RAT (RAT2). The wireless device 22 may further be configured to perform a measurement on one or more cells operating on F11. The carrier, F11, is also called as a serving-RAT carrier frequency. The carrier, F21, is also called as an inter-RAT carrier frequency. The wireless device 22 may further be configured to perform measurements on one or more cells operating on multiple inter-RAT carrier frequencies e.g., F21, F22, F23, etc. The wireless device 22 may further be configured to perform measurements on one or more cells operating on multiple carrier frequencies of the serving RAT, e.g., F11, F12, F13, etc.

The term carrier frequency is also called as component carrier (CC), frequency layer, layer, carrier, frequency, serving carrier, frequency channel, positioning frequency layer (PFL) etc. The carrier frequency belongs to certain frequency band, which may contain one or multiple carrier frequencies based on its passband (e.g., size of the band in frequency domain) and/or bandwidth of the carriers and/or the channel raster, etc. The carrier frequency related information is transmitted to the wireless device 22 by a network node 16 using a channel number or identifier via message, e.g., RRC. Examples of the channel number or identifier, which may be pre-defined, are absolute radio frequency channel number (ARFCN), NR-ARFCN, etc.

The wireless device 22 can be configured with a measurement gap pattern (MGP). Each of the measurement gap patterns is characterized by a measurement gap length (MGL), a measurement gap repetition period (MGRP), a measurement gap offset (MGO) relating the measurement gap, e.g., to the frame border of system frame number (SFN) 0, and a measurement gap timing advance (MGTA) which may shift the position of the measurement gap by 0, 0.25 or 0.5 ms relative to the measurement gap starting point given by MGO.

Alternatively, when both wireless device 22 and network node 16 support NCSG, the wireless device 22 can be configured with a network node 16 controlled small gap pattern (NCSG). Each of the NCSG pattern is characterized by a Measurement Length during which there is no gap (ML), a visible interruption repetition period (VIRP), a measurement gap offset (MGO) relating the NCSG, e.g., to the frame border of system frame number (SFN) 0, and a measurement gap timing advance (MGTA) which may shift the position of the measurement gap by 0, 0.25 or 0.75 ms relative to the NCSG starting point given by MGO. When wireless device 22 reports ‘nogap-noncsg’ for an inter-RAT band (e.g., a E-UTRA band), the wireless device 22 can support inter-RAT measurement (e.g., inter-RAT EUTRAN measurement) without gaps in that band.

Alternatively, when both wireless device 22 and network node 16 support inter-RAT measurement without gap, and the bandwidth (BW) of the target cell's RS for inter-RAT carrier frequency (e.g., CRS BW for EUTRAN frequency layer) are fully within the BW of the active BWP of serving NR cell, then wireless device 22 will perform inter-RAT measurement without gap for these inter-RAT carriers (e.g. EUTRAN frequency layers).

General Rules for Wireless Device 22 Supporting Inter-RAT Measurement without Gaps

The wireless device 22 supporting inter-RAT measurement (e.g., inter-RAT E-UTRAN measurement) without gaps, performs the inter-RAT measurement without gaps according to one or more of the following general rules.

### Scheduling Restriction

In general, when a scheduling restriction is applied to a signal in one or more time resources (e.g., symbol, slot, etc.) then the wireless device 22 is not expected or is not required to operate (e.g., transmit and/or receive) that signal in those time resources (e.g., may be called as restricted time resources). Examples of such signals are control channel (e.g., PDCCH, PUCCH), data channel (e.g., PDSCH, PUSCH), reference signal (e.g., CRS, SSB, PSSS, SSS, PRS SRS, CSI-RS etc), measurement reports (e.g., CSI reports, CQI report), feedback signals (e.g., ACK, NACK messages), etc. During the restricted time resources, the wireless device 22 is not scheduled with the signals for which the scheduling restriction is defined, e.g., as a rule, which can be pre-defined or configured by a network node 16.

When wireless device 22 supports inter-RAT measurement (e.g., inter-RAT E-UTRAN measurement) without gaps, wireless device 22 follows one or more of the scheduling restriction rules when performing measurements on one or more cells of an inter-RAT carrier frequency:
1. No scheduling restriction for NR PUCCH/PUSCH/SRS transmission and PDCCH/PDSCH/TRS/CSI-RS for CQI reception is needed when wireless device 22 supports inter-RAT E-UTRAN measurement without gaps.
2. No scheduling restriction for NR PUCCH/PUSCH/SRS transmission and PDCCH/PDSCH/TRS/CSI-RS for CQI reception is needed when wireless device 22 supports inter-RAT E-UTRAN measurement without gaps and the E-UTRAN frequency layers are in an inter-band.
3. No scheduling restriction for NR PUCCH/PUSCH/SRS transmission and PDCCH/PDSCH/TRS/CSI-RS for CQI reception is needed when wireless device 22 supports inter-RAT E-UTRAN measurement without gaps in an intra-band and additional no scheduling restriction capability.
4. The wireless device 22 is not expected to transmit NR PUCCH/PUSCH/SRS or receive NR PDCCH/PDSCH/TRS/CSI-RS for CQI on inter-RAT E-UTRAN RS symbols configured to be measured, and on Δt data symbol before and after each CRS symbols configured within inter-RAT E-UTRAN measurement window duration.
   a. The scheduling restriction can be applied if EUTRA-NR synchronization capability is enabled.
   b. The scheduling restriction can be applied for MO #i if EUTRA-NR synchronization capability is enabled only for MO #i.
   In one example, EUTRA-NR-sync capability can be defined as follow. When EUTRA-NR-sync is enabled, the wireless device 22 assumes frame boundary alignment (including half frame, subframe boundary alignment) across cells on the target Inter-RAT carrier and reference NR carrier is within a tolerance not worse than T1 and the SFNs of all cells on the target carrier and reference carrier are the same. The reference cell is the serving cell. T1 can be min (1 E-UTRAN symbol, 1 NR PDSCH symbol).
   In another example, EUTRA-NR-sync capability can be defined as the SFN and frame boundary across serving cell and inter-RAT neighbor cells is aligned.
5. The wireless device 22 is not expected to transmit NR PUCCH/PUSCH/SRS or receive NR PDCCH/PDSCH/TRS/CSI-RS for CQI on inter-RAT E-UTRAN RSSI measurement symbols configured to be measured, and on Δt data symbol before and after each CRS symbols configured within inter-RAT E-UTRAN measurement window duration.
   a. The scheduling restriction can be applied if EUTRA-NR synchronization capability is enabled.
6. The wireless device 22 is not expected to transmit NR PUCCH/PUSCH/SRS or receive NR PDCCH/PDSCH/TRS/CSI-RS for CQI on all symbols within inter-RAT E-UTRAN measurement window duration.
   a. The scheduling restriction can be applied if EUTRA-NR synchronization capability is not enabled.

When the wireless device 22 is configured to perform intra-band multicarrier (MC) operation (e.g., intra-band carrier aggregation (CA), intra-band dual connectivity, etc.), then the scheduling restrictions due to a given serving cell may also apply to all other serving cells in the same band on the symbols that fully or partially overlap with aforementioned restricted symbols. In intra-band MC operation, all the configured carriers (e.g., carriers of PCell, SCell, PSCell, etc.) belong to the same frequency band.

The scheduling restriction can be applied when wireless device 22 performs measurements in TDD bands on FR1 when the target inter-RAT measurements (e.g., inter-RAT E-UTRAN measurement) and the serving cell are on the same band.

The scheduling restriction can be applied when wireless device 22 is performing inter-RAT measurements (e.g., inter-RAT E-UTRAN measurements) with a different SCS than NR PDSCH/PDCCH on FR1.

The scheduling restriction can be applied when wireless device 22 is performing inter-RAT measurements (e.g., inter-RAT E-UTRAN measurements) with a different SCS than NR PDSCH/PDCCH on FR1 if the wireless device 22 supports the different SCS between inter-RAT measurement (e.g., inter-RAT E-UTRAN measurement) without gap and NR PDSCH/PDCCH reception.

The scheduling restriction can be applied to one or more measurements e.g., SS-RSRP, SS-SINR, SS-RSRQ or RSSI measurement.

### Inter-RAT (e.g., Inter-RAT E-UTRAN) Effective Measurement Window (EMW)

The wireless device 22 supporting inter-RAT measurement (e.g., inter-RAT E-UTRAN measurement) without gaps can perform inter-RAT measurement (e.g., inter-RAT E-UTRAN measurement) within an effective measurement window (EMW). The EMW can be defined based on one or more of the following rules or principles, which can be pre-defined or configured by a network node (e.g., NN1):
The inter-RAT (e.g. inter-RAT E-UTRAN) EMW can be based on the configured measurement gap pattern.
   If no measurement gap is needed, the inter-RAT E-UTRAN EMW can be the same as configured measurement gap pattern. No interruption is expected within the configured measurement gap pattern.
   If measurement gap is needed for other frequency layer measurement, the inter-RAT E-UTRAN EMW can be the same as configured measurement gap pattern.
      Network node 16 can further indicate which dedicated measurement gap occasion is used for inter-RAT E-UTRAN measurement. No interruption is expected within these gap occasions.
   If both wireless device 22 and network node 16 supports concurrent gaps and network node 16 configures concurrent measurement gap patterns, and network node 16 can further indicate the MGP as the inter-RAT E-UTRAN EMW to perform inter-RAT E-UTRAN measurement.
   If both wireless device 2 and network node 16 supports concurrent gaps and network node 16 configures concurrent MGPs, the inter-RAT E-UTRAN EMW can be the MGP with the largest MGRP.
   The MGP can be replaced with the NCSG pattern if both wireless device 22 and network node 16 supports NCSG and network node 16 configures NCSG pattern.
The inter-RAT (e.g., inter-RAT E-UTRAN) EMW can be based on the function of configured RS signal configuration such as SMTC configuration
   The EMW can be the same as PCell SMTC configuration
   The EMW can be the largest SMTC within configured serving cells
The inter-RAT (e.g., inter-RAT E-UTRAN) EMW can be pre-defined
   The periodicity of the EMW can be
      A solid value, such as 40 ms
      PCell SMTC, or the largest SMTC within configured serving cells
      Configured MGRP
   The offset of the EMW can be based on
      a pre-defined solid offset, such as 10 ms
      indicated by network node 16
      up to wireless device 22 implementation
      up to wireless device 22 implementation but not impacted NR measurement outside gaps
The inter-RAT (e.g., inter-RAT E-UTRAN) EMW can be obtained by the network node 16 (e.g., NN1) based on information received from the wireless device 22 via signaling message such as RRC. For example, the wireless device may signal to the network node one or more periodicities and/or offsets and/or durations of the EMW to the network node, and the network node may determine the periodicity and/or offset and/or duration of the EWM at least partly based on this signaling. For example, the wireless device may be aware of its own measurement performance and/or measurement conditions, and may therefore signal one or more suitable/suggested periodicities and/or offsets and/or durations of the EWM to the network node. In this way, the network node can select a EWM suitable for the wireless device.
In another example, the inter-RAT (e.g., inter-RAT E-UTRAN) EMW can be pre-defined. For example, the effective measurement period, measurement duration and/or measurement offset are defined.
   The measurement offset is based on the relation between SFN and the SMTC. For example, the offset equals 10 ms plus the immediately SMTC after SFN #0.
   The measurement offset is based on the relation between SFN and the MGP. For example, the offset equals 10 ms plus the immediately MG after SFN #0.
In another example the inter-RAT (e.g., inter-RAT E-UTRAN) EMW depends on or is function of a number (Nc) of carriers (e.g., inter-RAT carriers) configured for performing measurement without gaps. For example, the EMW=EMW11 if the Nc is below threshold; otherwise EMW=EMW12. In one example, EMW11<EMW12 and in another example, EMW11>EMW12. Inter-RAT measurement (e.g., inter-RAT E-UTRAN) measurement time

The wireless device 22 performs an inter-RAT measurement (e.g., RSRP, RSRQ, RS-SINR, RSSI, etc.) without gaps over a measurement time, which can be pre-defined or configured by a network node 16. Examples of measurement time are cell identification period, physical layer (L1) measurement period of an identified cell etc.

In one embodiment, when wireless device 22 supports inter-RAT E-UTRAN measurement without gaps, the wireless device 22 is able to identify a new detectable FDD/TDD cell within T_{Identify, E-UTRAN} following one of the possible delay:

$${T}_{Identify , E - UTRAN} = {T}_{BasicIdentify} \cdot \frac{480}{{T}_{effective ML} * \frac{480}{{T}_{period}}} \cdot {N}_{interRAT} ms$$

For example,
When wireless device 22 performs measurement based on configured MGRP

$${T}_{Identify , E - UTRAN} = {T}_{BasicIdentify} \cdot \frac{480}{{T}_{effective ML} * 480 / MGRP} \cdot {N}_{interRAT} ms$$

When wireless device 22 performs measurement based on configured SMTC

$${T}_{Identify , E - UTRAN} = {T}_{BasicIdentify} \cdot \frac{480}{{T}_{effective ML} * \frac{480}{SMTC period}} \cdot {N}_{interRAT} ms$$

When wireless device 22 performs measurement based on pre-defined periodicity or indicated by network node 16

$${T}_{Identify , E - UTRAN} = {T}_{BasicIdentify} \cdot \frac{480}{{T}_{effective ML} * \frac{480}{{T}_{period}}} \cdot {N}_{interRAT} ms$$

T_{effective ML} is the real measurement length for inter-RAT EUTRAN measurements.
If wireless device 22 performs the measurement based on an MGP, T_{effective ML}=MGL −2*RF retuning time. Where, RF retuning time=0.5 ms for E-UTRAN.
If wireless device 22 performs the measurement based on configured SMTC, T_{effective ML}=SMTC duration
If wireless device 22 performs the measurement based on a pre-defined pattern or indicated by NW, T_{effective ML} and T_{period} can be pre-defined, such as T_{effective ML}=5 ms and T_{period}=40 ms.

In one typical example, N_{interRAT} is the number of frequency layers for the inter-RAT (e.g., inter-RAT E-UTRAN) measurements.

In another example, N_{interRAT} is the number of frequency layers for all measurement without gaps, including both NR and the inter-RAT (e.g., inter-RAT E-UTRAN).

In another example, N_{interRAT} is the number of frequency layers to be measured within measurement gap. N_{interRAT}=CSSFwithin gap

In another example, N_{interRAT} is the number of frequency layers to be measured outside gap, including both NR and the inter-RAT (e.g., inter-RAT E-UTRAN) frequency layers. N_{interRAT}=CSSFoutside gap

Where, CSSFoutside gap is defined illustrated in FIG. 15.

In one example, Z is the number of configured inter-RAT EUTRAN MOs that are being measured outside of MG; otherwise, it is Z is 0.

In another example, Z is the number of configured inter-RAT EUTRAN MOS with inter-band of serving cells that are being measured outside of MG; otherwise, it is 0.

The measurement period is a function of the number of frequency layers for inter-RAT measurement without gaps. Alternatively, it can be a function of the number of frequency layers for all measurement without gaps, including both NR and the inter-RAT (e.g., inter-RAT E-UTRAN).

In one example, the measurement period can be 480*N_{interRAT}

In another example, the measurement period can be 480*N_{interRAT}*

Ceil(K_{gap_EUTRA}). K_{gap_EUTRA} is the scaling factor due to the inter-RAT EUTRAN measurement occasion overlapping with MGPs. For example, K_{gap_EUTRA}=Nₜₒₜₐₗ/N_{available}
Nₜₒₜₐₗ is the total number of associated gap occasions within the window, including those overlapped with other MG occasions within the window, and
N_{available} is the number of non-dropped measurement gap occasions after accounting for collisions between the measurement gaps by applying the measurement gap collision rule if concurrent gaps are configured.

### Embodiments for Wireless Device 22 Supporting Inter-RAT EUTRAN Measurement without Gaps with NCSG Capability

When both wireless device 22 and network node 16 supports NCSG capability, and wireless device 22 reports ‘nogap-nonscg’ for #N1 EUTRAN inter-bands and #N2 EUTRAN intra-bands with NR serving cells.

There is no scheduling restriction for the frequency layers within these #N1 E-UTRAN inter-bands.

The scheduling restriction can be applied for the frequency layers within these #N2 E-UTRAN intra-bands.

The inter-RAT E-UTRAN measurement without gap can be performed outside configured MGP. The network node 16 can configure a EMW for these MOs of inter-RAT E-UTRAN measurement without gap.

The total delay to identify a new cell can be expressed as follows:

$${T}_{Identify , E - UTRAN} = {T}_{BasicIdentify} \cdot \frac{480}{{T}_{effective ML} * \frac{480}{{T}_{period}}} \cdot {N}_{interRAT} ms$$

$${T}_{effective ML} = 5 ms , {T}_{period} = 40 ms$$

N_{interRAT} equals the total number of frequency layers in the E-UTRAN bands reporting ‘nogap-noncsg’

The scheduling restriction is applied for each effective ML occasion based on the network node 16 configured EMW.
When the frequency layers for inter-RAT EUTRAN measurement is in an inter-band of the serving cells reported ‘nogap-noncsg’, no scheduling restriction for NR PUCCH/PUSCH/SRS transmission and PDCCH/PDSCH/TRS/CSI-RS for CQI reception is needed.
When the frequency layers for inter-RAT EUTRAN measurement is in an intra-band of the serving cells reported ‘nogap-noncsg’ and the EMW is non-overlapping with SMTC, the wireless device 22 is not expected to transmit NR PUCCH/PUSCH/SRS or receive NR PDCCH/PDSCH/TRS/CSI-RS for CQI on inter-RAT E-UTRAN CRS/PSS/SSS symbols configured to be measured, and on 1 data symbol before and after each CRS/PSS/SSS symbol configured within inter-RAT E-UTRAN measurement window duration.
When the frequency layers for inter-RAT EUTRAN measurement is in an intra-band of the serving cells reported ‘nogap-noncsg’ and the EMW is fully overlapping with SMTC, the wireless device 22 is not expected to transmit NR PUCCH/PUSCH/SRS or receive NR PDCCH/PDSCH/TRS/CSI-RS for CQI on the whole EMW configured to be measured.
When the frequency layers for inter-RAT EUTRAN measurement is in an intra-band of the serving cells reported ‘nogap-noncsg’ and the EMW is partially overlapping with SMTC, the wireless device 22 is not expected to transmit NR PUCCH/PUSCH/SRS or receive NR PDCCH/PDSCH/TRS/CSI-RS for CQI on inter-RAT E-UTRAN CRS/PSS/SSS symbols configured to be measured which is overlapping with the SMTC and on X data symbols before and after each CRS/PSS/SSS symbol configured within inter-RAT E-UTRAN measurement window duration. Where, X can be 2, for example.

### Embodiments for Wireless Device 22 Supporting Inter-RAT EUTRAN Measurement without Gaps Capability in DSS

When both wireless device 22 and network node 16 supports inter-RAT E-UTRAN measurement without gaps capability for DSS, the scheduling restriction can be applied for the frequency layers for inter-RAT E-UTRAN measurement.

The inter-RAT E-UTRAN measurement without gap can be performed outside configured MGP. The EMW can base on the SMTC of NR DSS cell.

The total delay to identified a new cell can be

$${T}_{Identify , E - UTRAN} = {T}_{BasicIdentify} \cdot \frac{480}{{T}_{effective ML} * \frac{480}{{T}_{period}}} \cdot {N}_{interRAT} ms$$

$${T}_{effective ML} = 5 ms , {T}_{period} = SMTC period of the NR DSS cell$$

N_{interRAT} equals the total number of E-UTRAN frequency layers configured for DSS measurement.

The scheduling restriction is applied for each effective ML duration based on network node 16 configured EMW.

The scheduling restriction can be applied depends on whether wireless device 22 supports E-UTRAN-NR sync capability as described in the “General rules for wireless device 22 supporting inter-RAT measurement without gaps” section above and/or the capability of mix-numerology between at least two RATs, e.g., inter-RAT measurement on cells of RAT2 (e.g., inter-RAT E-UTRAN measurement) and data processing on cells of RAT1 (e.g., NR data processing).

The wireless device 22 capable of mix-numerology between at least two RATs indicate that the wireless device 22 can perform inter-RAT measurement on cells of one RAT (e.g., RAT2) while operating data signals (e.g., data channel, control channel, etc.) on cells of another RAT (e.g., RAT1) with different numerologies on the two RATs. The wireless device 22 may further indicate the supported mix numerologies on the two RATs. For example, the wireless device 22 indicates that it supports simultaneous operation of data using 30 KHz on RAT1 and inter-RAT measurement using 15 kHz on RAT2.

Examples of rules are:
When wireless device 22 does not support E-UTRAN-NR sync capability, the wireless device 22 is not expected to transmit NR PUCCH/PUSCH/SRS or receive NR PDCCH/PDSCH/TRS/CSI-RS for CQI on the whole EMW configured to be measured.
When wireless device 22 does not support the capability of mix-numerology between E-UTRAN measurement and NR data processing,
   When the EMW is non-overlapping with SMTC, the wireless device 22 is not expected to transmit NR PUCCH/PUSCH/SRS or receive NR PDCCH/PDSCH/TRS/CSI-RS for CQI on inter-RAT E-UTRAN CRS/PSS/SSS symbols configured to be measured, and on 1 data symbol before and after each CRS/PSS/SSS symbol configured within inter-RAT E-UTRAN measurement window duration.
   When the EMW is fully overlapping with SMTC, the wireless device 22 is not expected to transmit NR PUCCH/PUSCH/SRS or receive NR PDCCH/PDSCH/TRS/CSI-RS for CQI on the whole EMW configured to be measured.
   When the EMW is partially overlapping with SMTC, the wireless device 22 is not expected to transmit NR PUCCH/PUSCH/SRS or receive NR PDCCH/PDSCH/TRS/CSI-RS for CQI on inter-RAT E-UTRAN CRS/PSS/SSS symbols configured to be measured which is overlapping with the SMTC and on X data symbols before and after each CRS/PSS/SSS symbol configured within inter-RAT E-UTRAN measurement window duration. Where, X can be 2, for example.
Otherwise, no scheduling restriction is expected.

### Method in a Network Node for Scheduling a UE Supporting Gapless Measurement

A network node 16 (e.g., NN1) serving the wireless device 22 obtains information about the wireless device 22 capability related to inter-RAT measurement (e.g., inter-RAT E-UTRAN measurement) without gaps, and uses the obtained capability information for performing one or more operational tasks. Examples of the operational tasks are:
Adapting the scheduling of signals on the serving cell of the wireless device 22. For example, the network node 16 allocates the wireless device 22 for uplink transmission and/or downlink reception on signals only outside radio time used for scheduling restriction symbols, follows essentially the same rules as described for the wireless device 22 (i.e., in the wireless device 22 embodiments in sections: “General rules for wireless device 22 supporting inter-RAT measurement without gaps”, “Embodiments for wireless device 22 supporting inter-RAT EUTRAN measurement without gaps with NCSG capability”, and “Embodiments for wireless device 22 supporting inter-RAT EUTRAN measurement without gaps capability in DSS”).

The network node 16 (e.g., NN1) obtains the information about the wireless device 22 capability by receiving it from the wireless device 22 and/or by receiving it from another network node 16 (e.g., from another network node 16 during cell change procedure such as during HO, from core network node such as AMF, etc.)

One or more embodiments described herein provide the advantages of enhancing inter-RAT EUTRAN measurements and abbreviating interruption by inter-RAT EUTRAN measurements, meanwhile, power consumption is saved or made more efficient compared to other possible solutions. Further, the wireless device 22's behavior for inter-RAT EUTRAN measurement without gap is clearly defined as described herein.

As described above, a wireless device can perform inter-RAT E-UTRAN measurement without gaps within the effective measurement window (EWM). The measurement duration, measurement periodicity and offset with SMTC/SSB can be defined. One of the benefits to introduce such effective measurement window is both NW and UE have the common understanding on the occasions for the measurements and scheduling restriction.

In NR, scheduling restriction may be defined for a measurement without gap, such as intra-frequency measurement without gap, inter-frequency measurement without gap, and inter-frequency measurement with NCSG etc. Possible related scheduling restriction include UE performing measurements in TDD bands or with different SCS for inter-RAT E-UTRAN measurement without gap. For example, a UE receiving NR data with SCS=30 KHz and performing Inter-RAT E-UTRAN measurement can be a typical scenario to be consider.

A benefit of introducing the scheduling restriction is that the network can schedule the data outside the symbols to-be-measured. In NR, the to-be-measured symbols are SSB symbols or CSI-RS symbols. The question is how to apply the scheduling restriction for E-UTRAN measurement. The E-UTRAN measurement is based on CRS/PSS/SSS other than SSB symbols and the measurement can be performed in any CRS without restriction. One option is that when the target inter-RAT E-UTRAN frequency layers belong to an inter-band with the serving cells, no scheduling restriction is expected. Another option is that when the target inter-RAT E-UTRAN frequency layers belong to an inter-band with the serving cells, scheduling restriction is expected, such as UE performing measurements in TDD bands or with different SCS.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that May be Used in the Preceding Description Include:
Abbreviation Explanation
ACK Acknowledgement
AR Augmented reality
BLER Block error rate
BWP Bandwidth part
CP Cyclic prefix
CSI-RS Channel state information reference signals
CSSF Carrier-specific scaling factor
DCI Downlink control information
DL Downlink
eMBB Evolved mobile broadband
FDD Frequency division duplex
FR1 Frequency range 1
FR2 Frequency range 2
FR3 Frequency range 3
gNB Next generation Node B (5G base station)
HARQ Hybrid automatic repeat request
IMS IP Multimedia Subsystem
MAC Medium access control
MGL Measurement gap length
MGO Measurement gap offset
MGP Measurement gap pattern
MGRP Measurement gap repetition period
MGTA Measurement gap timing advance
NACK Negative acknowledgement
NR New radio (5G)
PBCH Physical broadcast channel
PDCCH Physical downlink control channel
PDSCH Physical downlink shared channel
PRS Positioning reference signals
PUCCH Physical uplink control channel
PUSCH Physical uplink shared channel
RAT Radio access technology
RRC Radio resource control
RRM Radio resource management
SCS Subcarrier spacing
SFN System frame number
SMTC SSB measurement timing configuration
SRS Sounding reference signal
SSB Synchronization signal and PBCH block
TDD Time division duplex
UE User equipment
UL Uplink
URLLC Ultra-reliable low-latency communication
VR Virtual reality
XR Extended reality

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### Example Embodiments (EE)

EE 1. A network node configured to communicate with a wireless device, the network node comprising:
processing circuitry configured to:
   determine a configuration for the wireless device to perform inter-radio access technology, RAT, measurement without measurement gaps; and
   cause transmission of the configuration to the wireless device.

EE 2. The network node of EE 1, wherein the configuration is based on at least one scheduling configuration, the at least one scheduling configuration including at least one of:
no scheduling restriction for uplink control channel and shared channel transmission and downlink control channel and shared channel reception for channel quality indicator, CQI, reception based on the wireless device supporting inter-RAT measurement without measurement gaps;
no scheduling restriction for uplink control channel and shared channel transmission and downlink control channel and shared channel reception for CQI reception based on the wireless device supporting inter-RAT measurement without measurement gaps and frequency layers are inter-band;
the wireless device is not expected to transmit on an uplink control channel and shared channel and receive on a downlink control channel and shared channel for CQI on inter-RAT reference signal symbols configured to be measured and on a data symbol before and after each reference signal symbol configured within an inter-RAT measurement window duration;
the wireless device is not expected to transmit on an uplink control channel and shared channel and receive on a downlink control channel and shared channel for CQI on inter-RAT RSSI measurement symbols configured to be measured and on a data symbol before and after each reference signal symbol configured within an inter-RAT measurement window duration; and the wireless device is not expected to transmit on an uplink control channel and shared channel and receive on a downlink control channel and shared channel for CQI on all symbols within an inter-RAT measurement window duration.

EE 3. The network node of EE 1, wherein the configuration define an effective measurement window, EMW, for performing inter-RAT measurement, the EMW being based on at least one of:
a configured measurement gap pattern;
a configured reference signal configuration;
a predefined configuration defining a periodicity and offset of the EMW;
information signaled in radio resource control, RRC, signaling; and
a number of carriers configured for performing measurements without gaps.

EE 4. The network node of EE 1, wherein the configuration defines a measurement time for performing inter-RAT measurements, the measurement time being based on at least one of:
one of a cell identification period and physical layer measurement period of an identified cell;
a detectable frequency division duplex, FDD/time division duplex, TDD, cell within a cell identification period; and
a number of frequency layers for inter-RAT measurement without measurement gaps.

EE 5. The network node of EE 1, wherein the configuration is based on network controlled small gap pattern, NCSG, capability of the wireless device and network node.

EE 6. The network node of EE 1, wherein the configuration is based on a dynamic spectrum sharing, DSS, capability of the wireless device and network node.

EE 7. A method implemented by a network node that is configured to communicate with a wireless device, the method comprising:
determining a configuration for the wireless device to perform inter-radio access technology, RAT, measurement without measurement gaps; and causing transmission of the configuration to the wireless device.

EE 8. The method of EE 7, wherein the configuration is based on at least one scheduling configuration, the at least one scheduling configuration including at least one of:
no scheduling restriction for uplink control channel and shared channel transmission and downlink control channel and shared channel reception for channel quality indicator, CQI, reception based on the wireless device supporting inter-RAT measurement without measurement gaps;
no scheduling restriction for uplink control channel and shared channel transmission and downlink control channel and shared channel reception for CQI reception based on the wireless device supporting inter-RAT measurement without measurement gaps and frequency layers are inter-band;
the wireless device is not expected to transmit on an uplink control channel and shared channel and receive on a downlink control channel and shared channel for CQI on inter-RAT reference signal symbols configured to be measured and on a data symbol before and after each reference signal symbol configured within an inter-RAT measurement window duration;
the wireless device is not expected to transmit on an uplink control channel and shared channel and receive on a downlink control channel and shared channel for CQI on inter-RAT RSSI measurement symbols configured to be measured and on a data symbol before and after each reference signal symbol configured within an inter-RAT measurement window duration; and the wireless device is not expected to transmit on an uplink control channel and shared channel and receive on a downlink control channel and shared channel for CQI on all symbols within an inter-RAT measurement window duration.

EE 9. The method of EE 7, wherein the configuration define an effective measurement window, EMW, for performing inter-RAT measurement, the EMW being based on at least one of:
a configured measurement gap pattern;
a configured reference signal configuration;
a predefined configuration defining a periodicity and offset of the EMW;
information signaled in radio resource control, RRC, signaling; and
a number of carriers configured for performing measurements without gaps.

EE 10. The method of EE 7, wherein the configuration defines a measurement time for performing inter-RAT measurements, the measurement time being based on at least one of:
one of a cell identification period and physical layer measurement period of an identified cell;
a detectable frequency division duplex, FDD/time division duplex, TDD, cell within a cell identification period; and
a number of frequency layers for inter-RAT measurement without measurement gaps.

EE 11. The method of EE 7, wherein the configuration is based on network controlled small gap pattern, NCSG, capability of the wireless device and network node.

EE 12. The method of EE 7, wherein the configuration is based on a dynamic spectrum sharing, DSS, capability of the wireless device and network node.

EE 13. A wireless device configured to communicate with a network node, the wireless device comprising:
processing circuitry configured to:
   receive a configuration for inter-radio access technology, RAT, measurement without measurement gaps; and
   perform inter-RAT measurement without measurement gaps on at least one cell based on the configuration.

EE 14. The wireless device of EE 13, wherein the configuration is based on at least one scheduling configuration, the at least one scheduling configuration including at least one of:

no scheduling restriction for uplink control channel and shared channel transmission and downlink control channel and shared channel reception for channel quality indicator, CQI, reception based on the wireless device supporting inter-RAT measurement without measurement gaps;
no scheduling restriction for uplink control channel and shared channel transmission and downlink control channel and shared channel reception for CQI reception based on the wireless device supporting inter-RAT measurement without measurement gaps and frequency layers are inter-band;
the wireless device is not expected to transmit on an uplink control channel and shared channel and receive on a downlink control channel and shared channel for CQI on inter-RAT reference signal symbols configured to be measured and on a data symbol before and after each reference signal symbol configured within an inter-RAT measurement window duration;
the wireless device is not expected to transmit on an uplink control channel and shared channel and receive on a downlink control channel and shared channel for CQI on inter-RAT RSSI measurement symbols configured to be measured and on a data symbol before and after each reference signal symbol configured within an inter-RAT measurement window duration; and
the wireless device is not expected to transmit on an uplink control channel and shared channel and receive on a downlink control channel and shared channel for CQI on all symbols within an inter-RAT measurement window duration.

EE 15. The wireless device of EE 13, wherein the configuration define an effective measurement window, EMW, for performing inter-RAT measurement, the EMW being based on at least one of:
a configured measurement gap pattern;
a configured reference signal configuration;
a predefined configuration defining a periodicity and offset of the EMW;
information signaled in radio resource control, RRC, signaling; and
a number of carriers configured for performing measurements without gaps.

EE 16. The wireless device of EE 13, wherein the configuration defines a measurement time for performing inter-RAT measurements, the measurement time being based on at least one of:
one of a cell identification period and physical layer measurement period of an identified cell;
a detectable frequency division duplex, FDD/time division duplex, TDD, cell within a cell identification period; and
a number of frequency layers for inter-RAT measurement without measurement gaps.

EE 17. The wireless device of EE 13, wherein the configuration is based on network controlled small gap pattern, NCSG, capability of the wireless device and network node.

EE 18. The wireless device of EE 13, wherein the configuration is based on a dynamic spectrum sharing, DSS, capability of the wireless device and network node.

EE 19. A method implemented by a wireless device that is configured to communicate with a network node, the method comprising:
receiving a configuration for inter-radio access technology, RAT, measurement without measurement gaps; and
performing inter-RAT measurement without measurement gaps on at least one cell based on the configuration.

EE 20. The method of EE 19, wherein the configuration is based on at least one scheduling configuration, the at least one scheduling configuration including at least one of:
no scheduling restriction for uplink control channel and shared channel transmission and downlink control channel and shared channel reception for channel quality indicator, CQI, reception based on the wireless device supporting inter-RAT measurement without measurement gaps;
no scheduling restriction for uplink control channel and shared channel transmission and downlink control channel and shared channel reception for CQI reception based on the wireless device supporting inter-RAT measurement without measurement gaps and frequency layers are inter-band;
the wireless device is not expected to transmit on an uplink control channel and shared channel and receive on a downlink control channel and shared channel for CQI on inter-RAT reference signal symbols configured to be measured and on a data symbol before and after each reference signal symbol configured within an inter-RAT measurement window duration;
the wireless device is not expected to transmit on an uplink control channel and shared channel and receive on a downlink control channel and shared channel for CQI on inter-RAT RSSI measurement symbols configured to be measured and on a data symbol before and after each reference signal symbol configured within an inter-RAT measurement window duration; and
the wireless device is not expected to transmit on an uplink control channel and shared channel and receive on a downlink control channel and shared channel for CQI on all symbols within an inter-RAT measurement window duration.

EE 21. The method of EE 19, wherein the configuration define an effective measurement window, EMW, for performing inter-RAT measurement, the EMW being based on at least one of:
a configured measurement gap pattern;
a configured reference signal configuration;
a predefined configuration defining a periodicity and offset of the EMW;
information signaled in radio resource control, RRC, signaling; and
a number of carriers configured for performing measurements without gaps.

EE 22. The method of EE 19, wherein the configuration defines a measurement time for performing inter-RAT measurements, the measurement time being based on at least one of:
one of a cell identification period and physical layer measurement period of an identified cell;
a detectable frequency division duplex, FDD/time division duplex, TDD, cell within a cell identification period; and
a number of frequency layers for inter-RAT measurement without measurement gaps.

EE 23. The method of EE 19, wherein the configuration is based on network controlled small gap pattern, NCSG, capability of the wireless device and network node.

EE 24. The method of EE 19, wherein the configuration is based on a dynamic spectrum sharing, DSS, capability of the wireless device and network node.

1. A method implemented by a wireless device (22) that is configured to communicate with a gNB, the method comprising:
receiving, from the gNB, a configuration for inter-radio access technology (RAT) measurement without measurement gaps, the configuration defining an effective measurement window for performing inter-RAT measurement without measurement gaps; and
performing inter-RAT measurement without measurement gaps in the effective measurement window on at least one cell based on the configuration.

2. The method of claim 1, wherein a scheduling restriction applies in the effective measurement window.

3. The method of claim 1, wherein a scheduling restriction applies in the effective measurement window when the inter-RAT measurement is performed by the wireless device with a different subcarrier spacing than used by the wireless device for reception of data or control signals at a serving cell of the wireless device.

4. The method of claim 1, wherein the configuration comprises a periodicity and offset of the effective measurement window.

5. The method of claim 1, wherein the configuration comprises a periodicity, offset and duration of the effective measurement window.

6. The method of claim 1, further comprising:
transmitting signaling to the gNB for determination of the effective measurement window.

7. The method of claim 6, wherein the signaling is radio resource control signaling.

8. The method of claim 6, wherein the signaling comprises:
one or more of:
one or more periodicities,
one or more offsets; and
one or moth durations,
of the effective measurement window.

9. The method of claim 1, wherein the wireless device is served by a new radio (NR) cell, and wherein the inter-RAT measurement without measurement gaps is performed on a long term evolution (LTE) cell.

10. The method of claim 1, wherein the configuration is based on at least one scheduling configuration, the at least one scheduling configuration including at least one of:
no scheduling restriction for uplink control channel and shared channel transmission and downlink control channel and shared channel reception for channel quality indicator, CQI, reception based on the wireless device supporting inter-RAT measurement without measurement gaps; and
no scheduling restriction for uplink control channel and shared channel transmission and downlink control channel and shared channel reception for CQI reception based on the wireless device supporting inter-RAT measurement without measurement gaps and frequency layers are inter-band.

11. The method of claim 1, wherein the effective measurement window for performing inter-RAT measurement without measurement gap is based on at least one of:
a configured measurement gap pattern;
a configured reference signal configuration;
a predefined configuration defining a periodicity, duration and offset of the effective measurement window;
information signaled in radio resource control, RRC, signaling; and
a number of carriers configured for performing measurements without gaps.

12. The method of claim 1, wherein the configuration defines a measurement time for performing inter-RAT measurements, the measurement time being based on at least one of:
one of a cell identification period and physical layer measurement period of an identified cell;
a detectable frequency division duplex, FDD/time division duplex, TDD, cell within a cell identification period; and
a number of frequency layers for inter-RAT measurement without measurement gaps.

13. A wireless device configured to communicate with a gNB, the wireless device comprising:
processing circuitry configured to:
receive, from the gNB, a configuration for inter-radio access technology (RAT) measurement without measurement gaps, the configuration defining an effective measurement window for performing inter-RAT measurement without measurement gaps; and
perform inter-RAT measurement without measurement gaps in the effective measurement window on at least one cell based on the configuration.

14. (canceled)

15. A method implemented by a gNB that is configured to communicate with a wireless device, the method comprising:
determining a configuration for the wireless device to perform inter-radio access technology, RAT, measurement without measurement gaps, wherein the configuration defines an effective measurement window for performing inter-RAT measurement without measurement gaps; and
causing transmission of the configuration to the wireless device.

16. The method of claim 15, wherein a scheduling restriction applies in the effective measurement window.

17. The method of claim 15, wherein a scheduling restriction applies in the effective measurement window when the inter-RAT measurement is performed by the wireless device with a different subcarrier spacing than used by the wireless device for reception of data or control signals at a serving cell of the wireless device.

18. The method of claim 15, further comprising:
obtaining information about a capability of the wireless device regarding inter-RAT measurement without gaps; and
adapting scheduling of signals on a serving cell of the wireless device using the obtained information.

19. The method of claim 18, wherein the adapting of scheduling comprises:
allocating the wireless device for one or both of uplink transmission and downlink reception of signals only outside radio time where the scheduling restriction applies.

20. (canceled)

21. (canceled)

22. The method of claim 15, further comprising:
receiving signaling from the wireless device; and
determining the effective measurement window based on the received signaling.

23.-28. (canceled)

29. A gNB configured to communicate with a wireless device, the gNB comprising:
processing circuitry configured to:
determine a configuration for the wireless device to perform inter-radio access technology, RAT, measurement without measurement gaps, the configuration defining an effective measurement window for performing inter-RAT measurement without measurement gaps; and
cause transmission of the configuration to the wireless device.

30. (canceled)
